(19) United States
(12) Patent Application Publication
(10) Pub. No.: US 2023/0108496 A1
(43) Pub. Date: Apr. 6, 2023

(54) Triggering a Subsequent Handover during a Dual-Active Protocol Stack Handover

(71) Applicant: Telefonaktiebolaget LM Ericsson (publ), Stockholm (SE)

(72) Inventors: Oscar Ohlsson, Bromma (SE); Jens Bergqvist, Linköping (SE); Johan Rune, Lidingö (SE); Pontus Wallentin, Linköping (SE); Icaro Leonardo Da Silva, Solna (SE)

(21) Appl. No.: 17/795,579

(22) PCT Filed: Jan. 13, 2021
(86) PCT No.: PCT/SE2021/050016

§ 371 Date: Jul. 27, 2022

Related U.S. Application Data
(60) Provisional application No. 62/968,635, filed on Jan. 31, 2020.

(51) Int. Cl. H04W 36/00; H04W 76/30

(52) U.S. Cl. CPC H04W 36/0069; H04W 76/30

(57) ABSTRACT

According to an example embodiment, a first target access node of a radio access network sends (910) a first handover command to a source access node serving a user equipment, UE, for transmission to the UE, the first handover command indicating a DAPS handover to a first target cell, served by the first target access node. Prior to the UE releasing the source cell for the DAPS handover, however, the first target access node determines (920) to perform a handover of the UE to a second target cell and transmits (930) a second handover command to the UE, the second handover command ordering a handover to the second target cell and including an explicit indication that the UE is to release the source cell upon receiving the second handover command.

### TECHNICAL FIELD

The present disclosure is related to connection reconfigurations, such as handovers, in wireless communication systems, and is more particularly related to techniques for handling connection reconfigurations during dual-active protocol stack (DAPS) handovers.

### BACKGROUND

### Wireless Communication Systems in 3GPP

FIG. 1 illustrates a simplified wireless communication system, with a user equipment (UE) 102 that communicates with one or multiple access nodes 103, 104, which in turn are connected to a network node 106. The access nodes 103, 104 are part of the radio access network (RAN) 100. The network node 106 may be, for example, part of a core network.

For wireless communication systems confirming to the 3rd Generation Partnership Project (3GPP) specifications for the Evolved Packet System (EPS), also referred to as Long Term Evolution (LTE) or 4G, as specified in 3GPP TS 36.300 and related specifications, the access nodes 103, 104 correspond typically to base stations referred to in 3GPP specifications as Evolved NodeBs (eNBs), while the network node 106 corresponds typically to either a Mobility Management Entity (MME) and/or a Serving Gateway (SGW). The eNB is part of the RAN 100, which in this case is the E-UTRAN (Evolved Universal Terrestrial Radio Access Network), while the MME and SGW are both part of the EPC (Evolved Packet Core network). The eNBs are inter-connected via the X2 interface, and connected to EPC via the S1 interface, more specifically via S1-C to the MME and S1-U to the SGW.

On the other hand, for wireless communication systems pursuant to 3GPP specifications for the 3GPP 5G System, 5GS (also referred to as New Radio, NR, or 5G), as specified in 3GPP TS 38.300 and related specifications, the access nodes 103, 104 correspond typically to base stations referred to as 5G NodeBs, or gNBs, while the network node 106 corresponds typically to either an Access and Mobility Management Function (AMF) and/or a User Plane Function (UPF). In this example, the gNB is part of the RAN 100, which in this case is the NG-RAN (Next Generation Radio Access Network), while the AMF and UPF are both part of the 5G Core Network (5GC). The gNBs are inter-connected via the Xn interface, and connected to 5GC via the NG interface, more specifically via NG-C to the AMF and NG-U to the UPF.

To support fast mobility between NR and LTE while avoiding a change of core network, LTE eNBs can also be connected to the 5G-CN via NG-U/NG-C and support the Xn interface. An eNB connected to 5GC is called a next generation eNB (ng-eNB) and is considered part of the NG-RAN. LTE connected to 5GC will not be discussed further in this document, but it should be noted that most of the solutions/features described for LTE and NR in this document also apply to LTE connected to 5GC. In this document, when the term LTE is used without further specification it refers to LTE-EPC.

5G is designed to support, among other things, new use cases requiring ultra-reliable low-latency communication (URLLC), such as factory automation and autonomous driving. To meet stringent requirements on reliability and latency during mobility, two new handover types are introduced in 5G Release 16. These are called make-before-break handover and conditional handover. The make-before-break handover, also known as Dual Active Protocol Stack (DAPS) handover, is relevant in the context of this invention disclosure and is described in more detail below after a review of the NG-RAN architecture and the legacy handover procedure.

Like E-UTRAN in 4G, the NG-RAN (also referred to as the NR, or “new radio” network) uses a flat architecture and consists of base stations, called gNBs, which are interconnected with each other by means of the Xn-interface. A simplified illustration of the NG-RAN architecture is shown in FIG. 11. As seen in the figure, gNBs are also connected by means of the NG interface to the 5GC, more specifically to the AMF (Access and Mobility Management Function) by the NG-C interface and to the UPF (User Plane Function) by means of the NG-U interface. The gNB in turn supports one or more cells which provides the radio access to the UE. The radio access technology (called New Radio, NR) is OFDM-based, like in LTE and offers high data transfer speeds and low latency. Note that “NR” is sometimes used to refer to the whole 5G system although it is, strictly speaking, only the 5G radio access technology.

It is expected that NR will be rolled out gradually on top of the legacy LTE network starting in areas where high data traffic is expected. This means that NR coverage will be limited in the beginning and users must move between NR and LTE as they go in and out of coverage. To support fast mobility between NR and LTE and avoid change of core network, LTE eNBs will also connect to the 5GC and support the Xn interface. An eNB connected to 5GC is called a next generation eNB (ng-eNB) and is considered part of the NG-RAN (see FIG. 11). LTE connected to 5GC is mentioned here simply for completeness and will not be considered further in this document.

### Mobility in RRC CONNECTED State in LTE and NR

Mobility in RRC_CONNECTED state is also known as handover. The purpose of handover is to move the UE from a source access node using a source radio connection (also known as source cell connection), to a target access node, using a target radio connection (also known as target cell connection). The handover may be caused by movement of the UE, for example, or for other reasons where the target cell is better positioned to serve the UE. The source radio connection is associated with a source cell controlled by the source access node. The target radio connection is associated with a target cell controlled by the target access node. In other words, during a handover, the UE moves from the source cell to a target cell. Sometimes the source access node or the source cell is referred to as the “source”, and the target access node or the target cell is sometimes referred to as the “target”. The source access node and the target access node may also be referred to as the source node and the target node, the source radio network node and the target radio network node or the source gNB and the target gNB.

In some cases, the source access node and target access node are different nodes, such as different eNBs or gNBs. These cases are also referred to as inter-node handover, inter-eNB handover or inter-gNB handover. In other cases, the source access node and target access node are the same node, such as the same eNB and gNB. These cases are also referred to as intra-node handover, intra-eNB handover or intra-gNB handover and covers the case then source and target cells are controlled by the same access node. In yet other cases, handover is performed within the same cell (and thus also within the same access node controlling that cell) - these cases are also referred to as intra-cell handover.

It should therefore be understood that the terms “source access node” and “target access node” each refer to a role served by a given access node during a handover of a specific UE. For example, a given access node may serve as source access node during handover of one UE, while it also serves as the target access node during handover of a different UE. And, in the case of an intra-node or intra-cell handover of a given UE, the same access node serves both as the source access node and target access node for that UE.

An inter-node handover can further be classified as an Xn-based or NG-based handover, depending on whether the source and target node communicate directly using the Xn interface or indirectly via the core network using the NG interface.

An RRC_CONNECTED UE in E-UTRAN or NG-RAN can be configured by the network to perform measurements of serving and neighbor cells and based on the measurement reports sent by the UE, the network may decide to perform a handover of the UE to a neighbor cell. The network then sends a Handover Command message to the UE (in LTE an RRConnectionReconfiguration message with a field called mobilityControlInfo and in NR an RRCReconfiguration message with a reconfigurationWithSync field).

These reconfigurations are prepared by the target access node upon a request from the source access node (over X2 or S1 interface in case of EUTRA-EPC or Xn or NG interface in case of NG-RAN-5GC) and take into account the existing Radio Resource Control (RRC) configuration and UE capabilities, as provided in the request from the source access node, as well as the capabilities and resource situation in the intended target cell and target access node. The reconfiguration parameters provided by the target access node contain, for example, information needed by the UE to access the target access node, e.g., random access configuration, a new C-RNTI assigned by the target access node, and security parameters enabling the UE to calculate new security keys associated to the target access node so the UE can send a Handover Complete message (in LTE an RRConnectionReconfiguratioComplete message and in NR an RRCReconfigurationComplete message) on SRB1 encrypted and integrity protected based on new security keys upon accessing the target access node.

FIG. 2 shows the signaling flow between the UE and source and target access node during an Xn-based inter-node handover in NR. Similar steps take place during an LTE handover. This might be regarded as the “legacy” handover procedure, i.e., a handover procedure that does not utilize “make-before-break” techniques and does not incorporate the various techniques described herein. Details of the steps shown in FIG. 2, which can be divided into handover preparation 212, handover execution 213, and handover completion 214, are provided below.
201-202. The UE and source gNB have an established connection and are exchanging user data. Due to some trigger, e.g., a measurement report from the UE, the source gNB decides to handover the UE to the target gNB.
203. The source gNB sends a HANDOVER REQUEST message to the target gNB with necessary information to prepare the handover at the target side. The information includes, among other things, the current source configuration and the UE capabilities.
204. The target gNB prepares the handover and responds with a HANDOVER REQUEST ACKNOWLEDGE message to the source gNB, which includes the handover command (a RRCReconfiguration message containing the reconfigurationWithSync field) to be sent to the UE. The handover command includes information needed by the UE to access the target cell, e.g., random access configuration, a new C-RNTI assigned by the target access node and security parameters enabling the UE to calculate the target security key so the UE can send the handover complete message (a RRCReconfigurationComplete message).
If the target gNB does not support the release of RRC protocol that the source gNB used to configure the UE, the target gNB may be unable to comprehend the UE configuration provided by the source eNB in the HANDOVER REQUEST. In this case, the target gNB can use so-called “full configuration” to reconfigure the UE for handover. Full configuration option includes an initialization of the radio configuration, which makes the procedure independent of the configuration used in the source cell. Otherwise, the target node uses so-called “delta configuration,” where only the delta to the radio configuration in the source cell is included in the handover command. Delta configuration typically reduces the size of the handover command, which increases the speed and robustness of the handover.
205. The source gNB triggers the handover by sending the handover command received from the target node in the previous step to the UE.
206. Upon reception of the handover command the UE releases the connection to the old cell before synchronizing and connecting to the new cell.
207-209. The source gNB stops scheduling any further DL or UL data to the UE and sends a SN STATUS TRANSFER message to the target gNB, the message indicating the latest PDCP SN transmitter and receiver status. The source node now also starts to forward user data to the target node, which buffers this data for now.
210. Once the UE the has completed the random access to the target cell, the UE sends the handover complete to the target gNB.
211. Upon receiving the handover complete message, the target node can start exchanging user data with the UE. The target node also requests the AMF to switch the DL data path from the UPF from the source node to the target node (not shown). Once the path switch is completed the target node sends the UE CONTEXT RELEASE message to the source node.

Handovers in NR like the one illustrated in FIG. 2 can be classified as break-before-make handovers, since the connection to the source cell is released before the connection to the target cell is established. These handovers therefore involve a short interruption of a few tens of milliseconds where no data can be exchanged between the UE and the network.

To shorten the interruption time during handover, a new type of handover, known as Dual Active Protocol Stack (DAPS) handover, is being introduced for NR and LTE in 3GPP Release 16. In DAPS handover the UE maintains the connection to the source cell while the connection to the target is being established. Thus, the DAPS handover can be classified as make-before-break handover. DAPS handover reduces the handover interruption but comes at the cost of increased UE complexity, as the UE needs to be able to simultaneously receive/transmit from/to two cells at the same time.

The DAPS procedure in NR is illustrated in FIG. 3. The steps of this procedure, which can be divided into handover preparation 317, handover execution 318, and handover completion 319, are described in detail below.
301-302. Same as steps 201-202 in the legacy handover in FIG. 2.
303-04. Similar to steps 203-204 in the legacy handover procedure, except that the source node indicates that the handover is a DAPS handover.
305. The source gNB triggers the handover by sending the handover command (a RRCReconfiguration message containing the reconfigurationWithSync field) received from the target node in the previous step to the UE. The handover command includes an indication to perform a DAPS handover.
306. Upon reception of the handover command with indication of a DAPS handover, the UE starts synchronizing to the target cell. Unlike in normal handover, the UE keeps the connection in the source cell and continues to exchange UL/DL data with the source gNB even after it has received the handover command. To decrypt/encrypt DL/UL data, the UE needs to maintain both the source and target security keys until the source cell is released. The UE can differentiate the security key to be used based on the cell which the DL/UL packet is received/transmitted on. If header compression is used the UE also needs to maintain two separate RObust Header Compression (ROHC) contexts for the source and target cell.
307-309. The source node sends a SN STATUS TRANSFER message to the target node and begins to forward DL data to the target gNB. Note that data that is forwarded may also be sent to the UE in the source cell, i.e., DL data may be duplicated. The target node buffers the DL data until the UE has connected with the target cell.
Note that the Xn message for conveying the DL and (possibly) UL receiver status for early data transfer in the DAPS handover is not yet decided in 3GPP. One could either re-use the existing SN STATUS TRANSFER message (as indicated in the figure) or one could define a new message called, e.g., EARLY FORWARDING TRANSFER.
310. Once the UE the has completed the random access to the target cell, the UE sends the handover complete (a RRCReconfigurationComplete message) to the target gNB. After this point, the UE receives DL data from both source and target cell while UL data transmission is switched to the target cell.
311. The target gNB sends a HANDOVER SUCCESS message to the source gNB, the message indicating the UE has successfully established the target connection.
312. Upon reception of the handover success indication, the source gNB stops scheduling any further DL or UL data to the UE and sends a final SN status transfer message to the target gNB, this message indicating the latest PDCP SN and HFN transmitter and receiver status.
313-315. The target gNB instructs the UE to release the source connection by sending an RRCReconfiguration message with “release source” indication. The UE releases the source connection and responds with a RRCReconfigurationComplete message. From this point on, DL and UL data is only received and transmitted in the target cell.
316. Same as step 211 in the legacy handover procedure in FIG. 2.

Note that, like in normal handover, the handover command (i.e., a RRCReconfiguration message containing the reconfigurationWithSync field) that is sent to the UE to trigger the handover procedure is generated by the target node (handling the target cell) but transmitted to the UE by the source node (in the source cell, i.e., the cell where the UE currently has its connection). In case of an inter-node handover, the handover command is sent from the target node to the source node within the Xn HANDOVER REQUEST ACKNOWLEDGE message as a transparent container, meaning that the source node does not change the contents of the handover command.

In order to not exceed the UE capabilities during a DAPS handover where the UE is simultaneously connected to both the source node (in the source cell) and the target node (in the target cell), the source node may need to reconfigure (also known as “downgrade”) the UE’s source cell configuration before triggering the DAPS handover. This reconfiguration can be done by performing an RRC connection reconfiguration procedure before the DAPS handover command is sent to the UE, i.e., before step 305. Alternatively, the updated (downgraded) source cell configuration can be sent together with the handover command, i.e., in the same RRC message and applied by the UE before the handover is executed. This can possibly speed up the DAPS handover by, for example, reducing processing time, as there is a single RRC message providing both source cell configuration downgrading and handover command.

Dual Active Protocol Stack (DAPS) handover is also being specified for LTE. An example of a DAPS inter-node handover is illustrated in FIG. 4, for the case of LTE.

Some highlights in this solution are:
Steps 401-404 are similar to conventional handover procedures.
In step 405, upon receiving the “DAPS HO” indication in the Handover Command, the UE maintains the connection to the source access node while establishing the connection to the target access node. That is, the UE can send and receive DL/UL user plane data via the source access node between step 405-408 without any interruption. After step 408, the UE has the target link available for UL/DL user plane data transmission, similar to the regular HO procedure.
In step 406, the source access node sends an SN status transfer message to the target access node, indicating UL PDCP receiver status and the SN of the first forwarded DL PDCP SDU. The uplink PDCP SN receiver status includes at least the PDCP SN of the first missing UL SDU and may include a bit map of the receive status of the out of sequence UL SDUs that the UE needs to retransmit in the target cell, if there are any such SDUs. The SN Status Transfer message also contains the Hyper Frame Number (HFN) of the first missing UL SDU as well as the HFN DL status for COUNT preservation in the target access node.
Once the connection setup with the target access node is successful, i.e., after performing random access to the target eNB in step 407 and sending the Handover Complete message in step 408, the UE maintains two data links, one to the source access node and one to the target access node. After step 408, the UE transmits the UL user plane data on the target access node similar to the regular HO procedure using the target access node security keys and compression context. Thus, there is no need for simultaneous UL user data transmission to both nodes which avoids UE power splitting between two nodes and also simplifies UE implementation. In the case of intra-frequency handover, transmitting UL user plane data to one node at a time also reduces UL interference which increases the chance of successful decoding at the network side.
The UE needs to maintain the security and compression context for both source access node and target access node until the source link is released. The UE can differentiate the security/compression context to be used for a PDCP PDU based on the cell which the PDU is transmitted on.
To avoid packet duplication, the UE may send a PDCP status report together with the Handover Complete message in step 408, indicating the last received PDCP SN. Based on the PDCP status report, the target access node can avoid sending duplicate PDCP packets (i.e., PDCP PDUs with identical sequence numbers) to the UE, i.e., PDCP packets which were already received by the UE in the source cell.
Steps 409, 410, 411, and 412 are similar to conventional handovers. The release of the source cell in step 413 can, e.g., be triggered by an explicit message from the target access node (not shown in the figure) or by some other event such as the expiry of a release timer.

As an alternative to source access node starting packet data forwarding after step 405 (i.e., after sending the Handover Command to the UE, also known as “early packet forwarding”), the target access node may indicate to the source access node when to start packet data forwarding. For instance, the packet data forwarding may start at a later stage when the link to the target cell has been established, e.g., after the UE has performed random access in the target cell or when the UE has sent the RRC Connection Reconfiguration Complete message to the target access node (also known as “late packet forwarding”). By starting the packet data forwarding in the source access node at a later stage, the number of duplicated PDCP SDUs received by the UE from the target cell will potentially be less and by that the DL latency will be somewhat reduced. However, starting the packet data forwarding at a later stage is also a trade-off between robustness and reduced latency if, e.g., the connection between the UE and the source access node is lost before the connection to the target access node is established. In such case there will be a short interruption in the DL data transfer to the UE.

For the purposes of the present disclosure, the term DAPS handover should be understood as referring to a handover procedure in which the UE maintains a distinct uplink/downlink connection to the source base station after reception of an RRC message for handover and until releasing the source cell after successful random access to the target base station. Thus, unlike Rel-14 make before break handovers, with a DAPS handover the UE does not release the connection to the source base station until after its first transmission (e.g., the PRACH preamble) to the target base station.

It will be appreciated that a DAPS handover in accordance with the above definition may carry a different name, in various contexts. It will be further appreciated, however, that a DAPS handover is distinct from such things as soft handover, MIMO, multi-transmission point transmission/reception, dual connectivity, etc. Each of these also involve redundant paths from the UE to the network, where an endpoint combines information from the paths into a reliable stream of data. However, the combining is done on different protocol layers, and most of these do not involve a handover in that a source cell is released once a connection to the target cell is established. In soft handover, the same bitstream is transmitted to the UE from two different cells, where combining is done at the physical layer. With soft handover, there are not distinct UL/DL links between the UE and two base stations, but merely a redundant bitstream. The other examples mentioned above involve redundant paths or transmission layers, but these redundant paths or transmission layers are distinct from a handover scenario.

FIG. 5 shows an example of the protocol stack at the UE side at Dual Active Protocol Stack (DAPS) handover. Each user plane radio bearer has an associated PDCP entity which in turn has two associated RLC entities - one for the source cell and one for the target cell. The PDCP entity uses different security keys and ROHC contexts for the source and target cell while the SN allocation (for UL transmission) and re-ordering/duplication detection (for DL reception) is common. This may be contrasted with dual connectivity (DC), for example, where a common PDCP entity is used, on top of separate RLC/MAC/PHY stacks for each of the two dual-connectivity carriers.

Note that in case of NR, there is an additional protocol layer called Service Data Adaptation Protocol (SDAP), on top of PDCP. SDAP is responsible for mapping QoS flows to bearers. This layer is not shown in FIG. 5 and will not be discussed further in this document.

### SUMMARY

In DAPS handover as presently specified, the source connection is released by the target node using a separate RRC reconfiguration procedure after the target connection has been established. The UE then receives an indication in an RRCReconfiguration message that indicates that it shall release the connection to the source cell, i.e., the cell to which it was connected when the DAPS handover was started.

In some cases, the UE should perform a new handover (to a second target cell) immediately after the first (DAPS) handover to the first target cell. As an example, the UE has a connection in a first cell (C₁) and performs a DAPS handover to a second cell (C₂). When entering C₂, the UE is instructed to perform a subsequent handover to a third cell (C₃). The second handover could then either also be run as a DAPS handover or as handover not using DAPS. The UE would thus receive a new handover command (i.e., RRCReconfiguration message) just when it has entered cell C₂. However, since the first handover was a DAPS handover, and there thus is a need to release the connection to the source cell (C₁), the UE would need to receive both a first RRCReconfiguration message with the indication to release the source cell (C₁) and a second RRCReconfiguration message that triggers the subsequent handover to the new, second target cell (C₃). The reason is that the new (second) target node, which controls the second target cell (C₃), and which prepares the handover command, does not know that the UE has a connection to a previous source cell (C₁), which needs to be released (unless the second target node and the first target node are one and the same, i.e., both cell C₂ and cell C₃ are controlled by the same node). It cannot thus include an indication for it in the RRCReconfiguration message (handover command).

This may delay a subsequent handover since there is a delay to wait for the first RRC reconfiguration procedure to complete before a new handover can be triggered. Delayed handover in turn results in an increased risk of radio link failure or handover failure. The techniques described herein enable the network to transmit a subsequent handover command message to a UE and enable the UE to receive and process the subsequent handover command message, when a DAPS handover is in progress for that UE. The result is that a well-defined UE behavior can be ensured when the UE receives this subsequent handover command.

Several embodiments of the presently disclosed techniques provide solutions for the UE to release the source connection when a new handover is triggered after a DAPS handover, without the need for a reconfiguration message dedicated for that purpose. These techniques enable a subsequent handover to be performed faster after a DAPS handover, which reduces the risk of radio link failure.

An example method, according to some embodiments of these techniques, is carried out by a first target access node of a radio access network. This example method comprises the step of sending a first handover command to a source access node serving a UE, for transmission by the source access node to the UE. This first handover command indicates a DAPS handover from a source cell served by the source access node to a first target cell, served by the first target access node. Prior to the UE releasing the source cell for the DAPS handover, the first target access node determines to perform a handover of the UE to a second target cell, served by a second target access node. The first target access node then transmits a second handover command to the UE, the second handover command ordering a handover from the first target cell to the second target cell. This second handover command includes an explicit indication that the UE is to release the source cell upon receiving the second handover command.

Other embodiments include a corresponding example method carried out in a UE, for handling connection reconfiguration commands received during ongoing DAPS, handovers. This example method includes the step of receiving, prior to releasing a source cell from a DAPS handover from the source cell to a first target cell, a connection reconfiguration command from the first target cell. The method further comprises the step of releasing the UE’s connection to the source cell, responsive to the connection reconfiguration message command. The connection reconfiguration message referred to here is a handover command specifying a handover to a second target cell, where the handover command includes an explicit indication that the UE’s connection to the source cell is to be released.

Other embodiments described herein are several variations of the above-described methods, as well as corresponding apparatuses adapted to carry out these and similar methods, associated computer program products and non-transitory computer-readable mediums.

### BRIEF DESCRIPTION OF THE FIGURES

FIG. 1 is a simplified illustration of a wireless communication system.

FIG. 2 illustrates handover in NR.

FIG. 3 is a signaling diagram illustrating a dual-active protocol stack (DAPS) handover in NR.

FIG. 4 is a signaling diagram illustrating a DAPS handover for LTE.

FIG. 5 is a block diagram illustrating a dual active protocol stack (DAPS) on a UE.

FIG. 6 is a signaling flow according to some embodiments of the presently disclosed techniques.

FIG. 7 is a signaling flow according to other embodiments of the presently disclosed techniques.

FIG. 8 is a flow diagram illustrating an exemplary method in a UE.

FIG. 9 is a flow diagram illustrating an exemplary method in a first target access node.

FIG. 10 is a flow diagram illustrating an exemplary method in a second target access node.

FIG. 11 illustrates the NG-RAN architecture.

FIG. 12 is a block diagram illustrating an example UE.

FIG. 13 is a block diagram illustrating an example network node.

FIG. 14 is a block diagram of an exemplary wireless network configurable according to various exemplary embodiments of the present disclosure.

FIG. 15 is a block diagram of an exemplary user equipment (UE) configurable according to various exemplary embodiments of the present disclosure.

FIG. 16 is a block diagram of illustrating a virtualization environment that can facilitate virtualization of various functions implemented according to various exemplary embodiments of the present disclosure.

FIGS. 17-18 are block diagrams of exemplary communication systems configurable according to various exemplary embodiments of the present disclosure.

FIGS. 19-22 are flow diagrams illustrating various exemplary methods and/or procedures implemented in a communication system, according to various exemplary embodiments of the present disclosure.

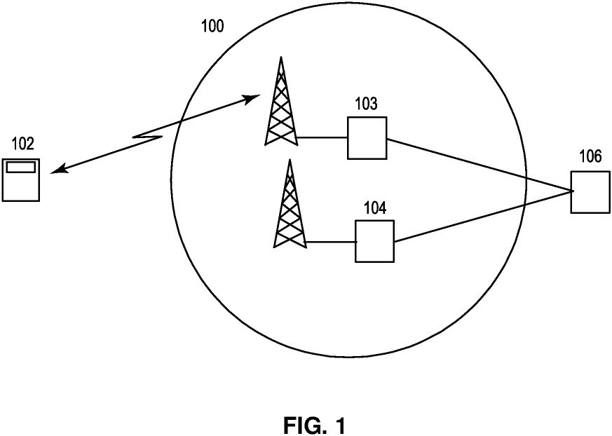

### DETAILED DESCRIPTION

This disclosure details solutions for a UE to release the source connection when a new handover is triggered after a DAPS handover, to avoid delaying this subsequent handover. The various solutions described herein are discussed in the context of scenarios with two sequential handovers, a first handover from cell C1 and node N1 to cell C2 and node N2, and a subsequent second handover from cell C2 and node N2 to cell C3 and node N3. C1 and N1 are referred to as the source cell and the source node (or source gNB). C2 and N2 are referred to as the first target cell and the first target node (or first target gNB). Note that the first target cell and the first target node acts as source cell and source node in the second handover. C3 and N3 are referred to as the second target cell and the second target node (or the second target gNB). It should also be understood that while these techniques are described using mainly NR terminology, they are equally applicable to LTE, where, for instance, RRCConnectionReconfiguration/RRCConnectionReconfigurationComplete messages in LTE correspond to, or (in the context of this document) are equivalent to RRCReconfiguration/RRCReconfigurationComplete in NR and the handover command in LTE consists of an RRCConnectionReconfiguration message including a mobilityControlInfo information element (IE).

The solutions described herein include various alternatives and variations, including:
The UE implicitly releases the source cell connection if it receives a new handover command (i.e., RRCReconfiguration message) in the first target cell and it still has a connection to the previous source cell. In this document, a DAPS handover described as “ongoing” or “being performed” by the UE is one in which the UE has not yet released its connection to the source cell for the DAPS handover.
As one alternative, the second target node includes an indication to release the previous source cell in the handover command (i.e., RRCReconfiguration message) that configures the new (subsequent) handover. To enable this, the first target node includes information to the second target node (e.g., in the Xn HANDOVER REQUEST message) that the second target node shall include an indication to the UE in the Handover Command to release the (previous) source cell connection.
As another alternative, the first target node (which acts as the source node in the second handover) does not inform the second target node about the need to release the UE’s connection in the previous source cell (i.e., the source cell of the first handover), but instead updates the handover command (i.e., RRCReconfiguration message), which is received from the second target node in the Handover Request Acknowledge message, e.g., in the transparent container with RRC information, which is denoted “Target NG-RAN node To Source NG-RAN node Transparent Container” (XnAP terminology) and which contains the HandoverCommand (RRC terminology), before transmitting it to the UE. The update then consists of that the first target node (in its role as source node in the second handover) adds the indication to the UE to release the connection in the previous source cell.

As yet another alternative, the UE receives a new handover command (i.e., RRCReconfiguration message) which instructs the UE to perform a DAPS handover to a second target cell, and this new handover command does not instruct the UE to release the source cell connection. In this alternative, the UE keeps the connections to both the source cell and first target cell while connecting to the second target cell.

All of these techniques enable a subsequent handover to be performed faster after a DAPS handover, which reduces the risk of radio link failure.

According to a first solution variant, or embodiment, if a subsequent handover is triggered by the target node before the source connection has been released after a DAPS handover, the UE releases the source connection when it receives the handover command.

The release of the source cell can either be triggered implicitly from the reception of the handover command (e.g., by introducing a rule in industry standards) or it can be triggered explicitly by including an indication in the handover command. In the latter case, since it is the second target node that prepares the handover command, the first target node (now acting as source node in the second handover) informs the second target node in the HANDOVER REQUEST message that the (previous) source cell connection has not yet been released, so that the second target node can include the release indication in the handover command. As an alternative, the first target node (acting as source node in the second handover) instead changes the content of the handover command to also include an indication to the UE to release the previous source cell connection.

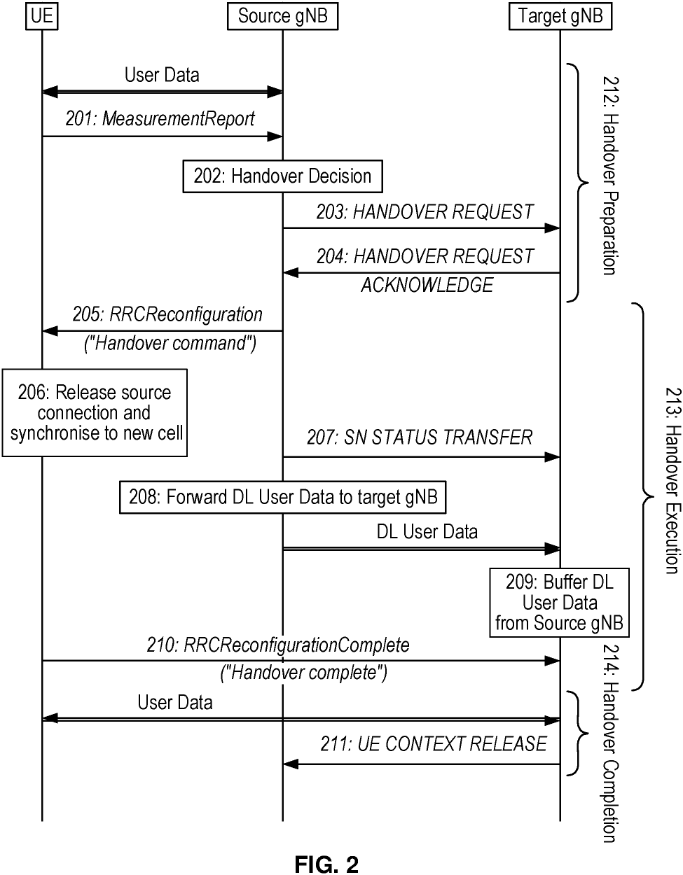

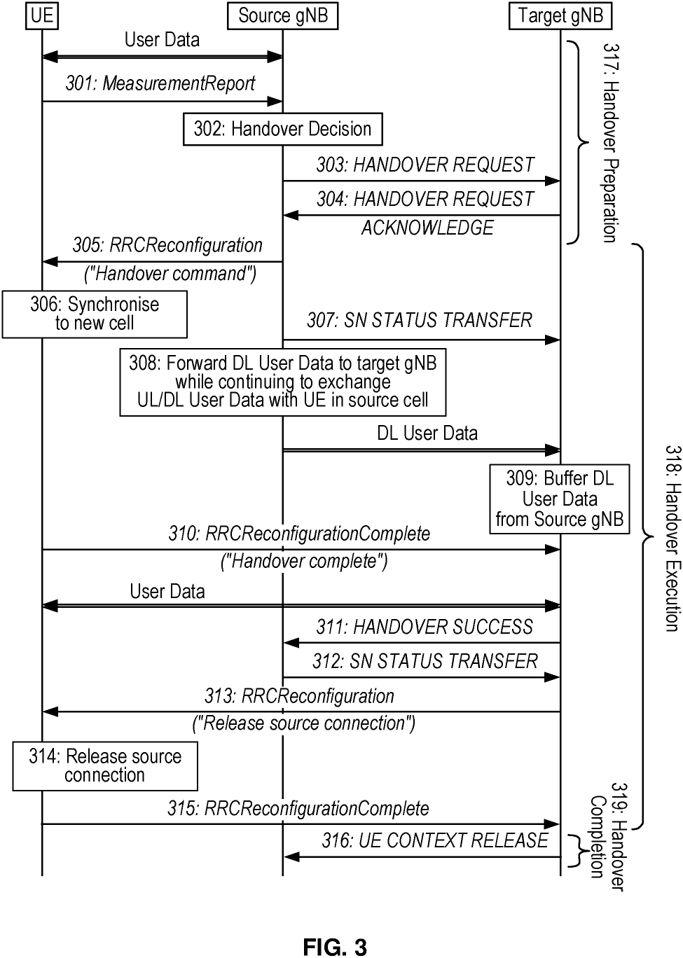

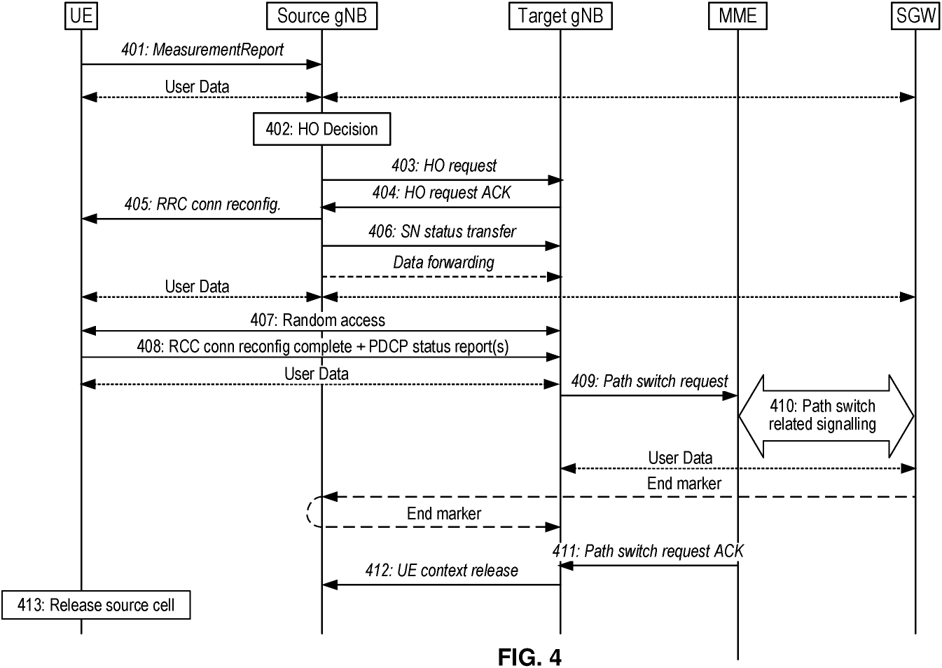

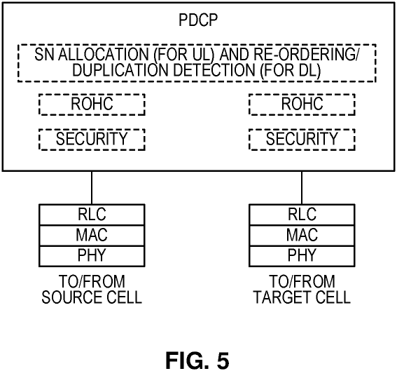

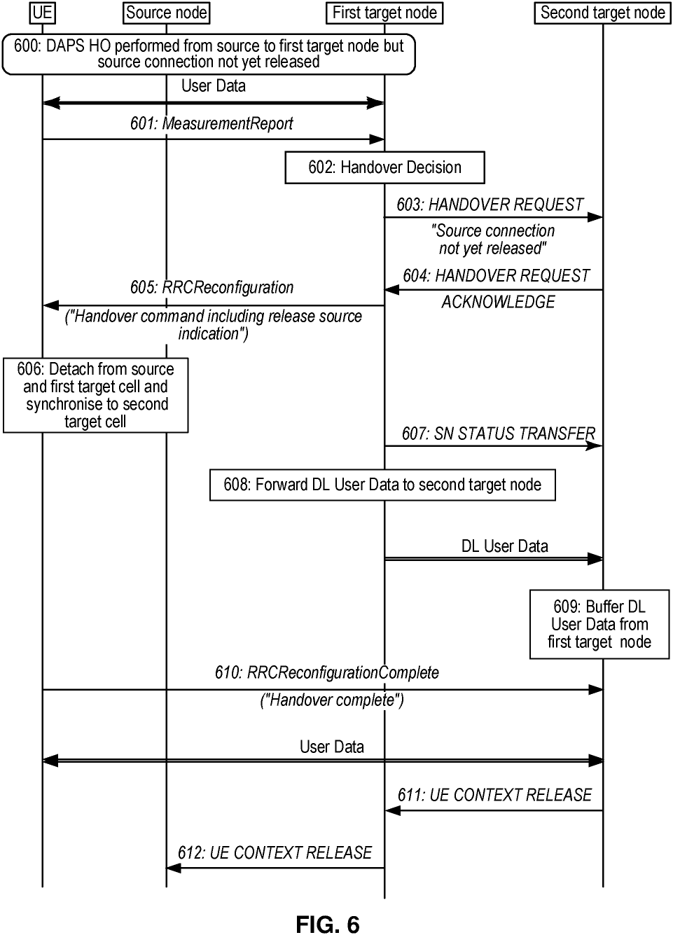

A signaling flow for this procedure for handling a subsequent handover triggered after DAPS handover begins but before source connection release is illustrated in FIG. 6. In FIG. 6 it is assumed that the subsequent handover is a regular handover, although it could also be another DAPS handover. The steps shown in FIG. 6 are described below.
600. The UE has been handed over from a source node to a first target node using DAPS handover, but the source cell connection has not yet been released, i.e., steps 301-312 of the DAPS handover procedure in FIG. 3 have been performed.
601-602. Due to some trigger, e.g., a measurement report from the UE, the first target gNB decides to handover the UE to a second target cell, which may be controlled by the same (first) target gNB or a second, different target gNB. In this example, the second target cell is controlled by a different, second target gNB.
603-604. Similar to steps 203-204 in the legacy handover procedure in FIG. 2. In addition, if the source cell connection is released using an explicit indication in the handover command, the first target node indicates to the second target node in the HANDOVER REQUEST message that the source cell connection has not yet been released. Based on this indication the second target node can include the “release source cell connection” when it constructs the handover command.
605. Same as step 205 in the legacy handover procedure, albeit here including a release source connection indication, in case an embodiment where an explicit release source connection indication is included in the handover command is used.
606. Upon receiving the handover command the UE releases the connections in the source cell and (since the second handover is a non-DAPS handover in this example) in the first target cell before synchronizing and connecting to the second target node in the second target cell.
The release of the source connection can either be triggered implicitly based on the reception of handover command or it can be triggered explicitly based on an explicit indication in the handover command. The former approach has the advantage that the second target node can generate the handover command without being aware that UE is still connected to the source node in the source cell, i.e., the “Source connection not yet released” indication in the HANDOVER REQUEST is not required to be present or is not required to be parsed/comprehended by the second target node. This is useful in case the second target node is of an older release or for some other reason does not support the DAPS handover feature, for example. One could also consider a combination of the two approaches where the former approach is used in case of handover using full configuration and the latter approach is used in case of handover using delta configuration. Another alternative is that first target node modifies the handover command received from the second target node to also include an indication to the UE to release the previous source cell connection. This alternative is thus a solution variant with an explicit release source cell connection in the handover command, but where the second target node can be unaware and does not have to support the DAPS handover feature.
607-611. Same as steps 207-211 in the legacy handover procedure.
612. The first target node sends the UE CONTEXT RELEASE message to the source node to release the UE context in the source node. This message may also be possible to send earlier.

The implicit release solution described above (without explicit release source cell connection indication) can also be applied to other cases besides handover. For example, the UE may release the source cell at reception of any kind of RRCReconfiguration message from the target (i.e., not just upon reception of a handover command (i.e., an RRCReconfiguration message containing a reconfigurationWithSync field)). The UE may also implicitly release the source connection when the UE changes state, for example, when the UE moves from connected to idle or inactive state. In this case the release of the source cell may be triggered by the reception of the RRCRelease message which orders the UE to move from connected to idle or inactive state.

As yet another option, the first target node may include in the handover command for the first handover (the DAPS handover from the source cell to the first target cell) an indication to the UE whether it should accept implicit source cell connection release indications (any of the variants, i.e., source cell connection release triggered only by a handover command, any RRCReconfiguration message or any RRC message received in the first target cell) or require an explicit indication to trigger release of the source cell connection

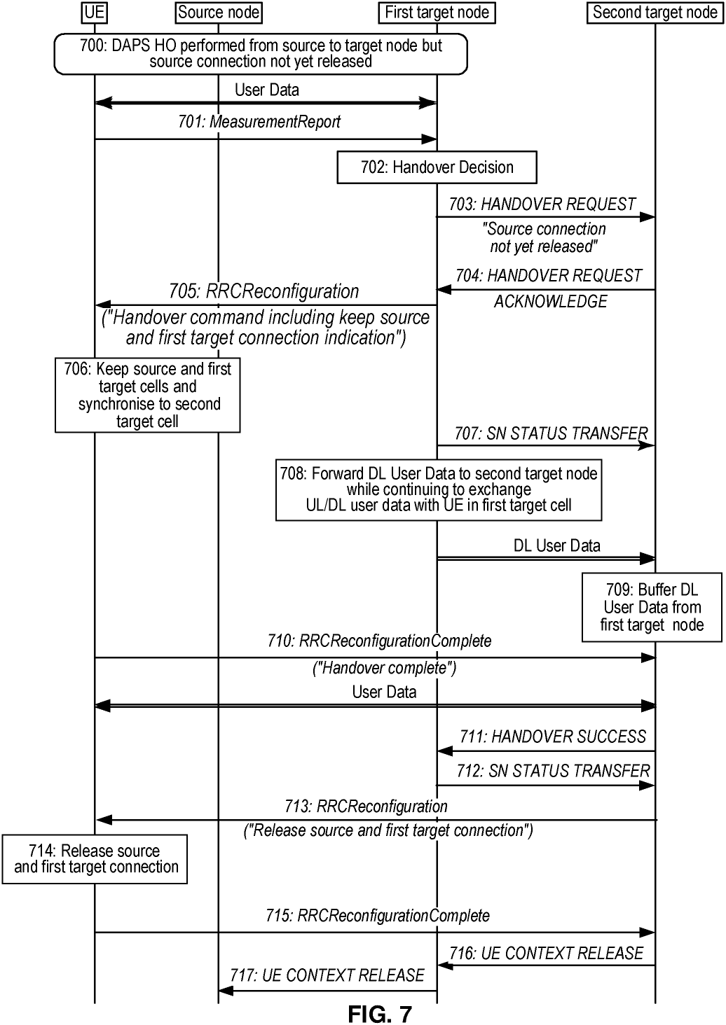

FIG. 7 illustrates an alternative solution. The steps shown in that procedure are described below.
700-703. Same as steps 600-603 in FIG. 6.
704. Similar to steps 203-204 in the legacy handover procedure in FIG. 2. In addition, based on indication from the first target node in the HANDOVER REQUEST message in step 703 that the source cell connection has not yet been released, the second target node includes the “keep source and first target connection indication” when it constructs the handover command
705. Same as step 205 in the legacy handover procedure, albeit here an indication to keep source and first target connection is included in the handover command.
706. Upon receiving the handover command including a keep source and first target connection indication, the UE keeps both the source and first target connections while synchronising to the second target cell and continues to exchange data packets with the source node and first target node.
707-709. The first target node sends a SN STATUS TRANSFER message to the second target node and begins to forward DL data to the second target node. Note that data that is forwarded may also be sent to the UE in the first target cell, i.e., downlink (DL) data may be duplicated. The second target node buffers the DL data until the UE has connected with the second target cell
710. Once the UE the has completed the random access to the second target cell, the UE sends the handover complete (a RRCReconfigurationComplete message) to the second target node. The UE switches UL data transmission to the target cell. In one variant, it keeps the connections to first target cell and the source cell. In another variant, it releases the source cell connection and keeps connections to the first and second target cells. In yet another variant, it releases the first target cell connection and keeps the source cell connection. Which of these variants to use may be indicated in the handover command message, stated in the specification, or up to UE implementation.
711. The second target node sends a HANDOVER SUCCESS message to the first target node indicating the UE has successfully established the second target cell connection.
712. Upon reception of the handover success indication, the first target node stops scheduling any further DL or UL data to the UE and sends a final SN status transfer message to the second target node indicating the latest PDCP SN and HFN transmitter and receiver status.
713-715. The second target node instructs the UE to release the source and/or target cell connection(s) by sending an RRCReconfiguration message. In one variant, the second target node instructs the UE to release both the source and first target cell connections using an indicator in the message, as illustrated in FIG. 7. In another variant, the second target node instructs the UE to release the first target cell connection using an indicator in the message. In yet another variant, the second target node instructs the UE to release the source cell connection using an indicator in the message The UE releases the source and/or target cell connection(s) and responds with a RRCReconfigurationComplete message. From this point on, DL and UL data is only received and transmitted in the second target cell.
716-717. The second target node also requests the AMF to switch the DL data path from the UPF from the source node (or from the first target node if the data path was already switched from the source node to the first target node during the first DAPS handover) to the second target node (not shown). Once the path switch is completed the second target node sends the UE CONTEXT RELEASE message to the first target node. The first target node then sends the UE CONTEXT RELEASE message to the source node.

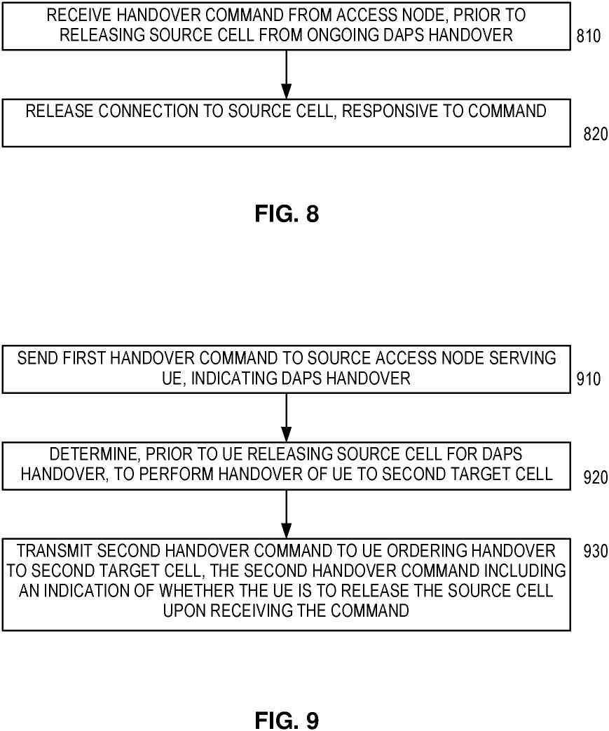

Some of the embodiments described above may be further illustrated with reference to FIG. 8, which depicts an example method and/or procedure performed by a UE for handling connection reconfiguration commands received during ongoing dual-active protocol stack (DAPS) handovers. The method illustrated in FIG. 8 should generally be understood as a generalization of the UE-related techniques descried above and is intended to encompass those techniques.

As shown at block 810, the illustrated method includes the step of receiving, prior to releasing a source cell from a DAPS handover from the source cell to a first target cell, a connection reconfiguration command from the first target cell. This connection reconfiguration message may be a handover command specifying a handover to a second target cell or a message ordering the UE to move from a connected state to an idle or inactive state, for example.

As shown at block 820, the method further includes the step of releasing the UE’s connection to the source cell, responsive to the connection reconfiguration message command.

In some embodiments, the connection reconfiguration command is a message ordering the UE to move from a connected state to an idle or inactive state, where the method comprises releasing the UE’s connection to the source cell response to the message ordering the UE to move from the connected state to an idle or inactive state, without receiving any explicit indication that the UE’s connection to the source cell is to be released.

In other embodiments, the connection reconfiguration message is a handover command, the handover command specifying a handover to a second target cell. In some of these embodiments, the handover command does not include an explicit indication that the UE’s connection to the source cell is to be released, and the method comprises releasing the UE’s connection to the source cell without receiving any explicit indication that the UE’s connection to the source cell is to be released. In some of these embodiments, the releasing of the UE’s connection to the source cell without receiving any explicit indication that the UE’s connection to the source cell is to be released is conditioned upon having previously received an indication that implicit source cell release is permitted.

In other embodiments where the connection reconfiguration message is a handover command, the handover command includes an explicit indication that the UE’s connection to the source cell is to be released. In others, releasing the UE’s connection to the source cell is in response to determining whether the handover command includes an explicit indication that the UE’s connection to the source cell is to be kept. In some of these latter embodiments, releasing the UE’s connection to the source cell is in response to determining that the handover command does not include an explicit indication that the UE’s connection to the source cell is to be kept.

In any of several of the embodiments described above, the handover command may be an RRCConnectionReconfiguration message, in an LTE network, or a RRCReconfiguration message, in an NR network. The handover command may include an indication to perform a DAPS handover to the second target cell. In this case, the method further comprises maintaining the UE’s connection to the first target cell until the UE is instructed to release the UE’s connection to the first target cell or until the UE receives a further handover command.

FIG. 9 illustrates an example method carried out by a first target access node of a radio access network. Again, this method may be considered to be a generalization of several of the techniques described above, and thus any of the variants of those techniques discussed above are applicable to the method of FIG. 9.

As shown at block 910, the method begins with sending a first handover command to a source access node serving a user equipment, UE, for transmission by the source access node to the UE. This first handover command indicates a dual-active protocol stack, DAPS, handover from a source cell served by the source access node to a first target cell, served by the first target access node. The method further comprises, prior to the UE releasing the source cell for the DAPS handover, determining to perform a handover of the UE to a second target cell served by a second target access node. This is shown at block 920. Finally, the method comprises transmitting a second handover command to the UE, the second handover command ordering a handover from the first target cell to the second target cell. The second handover command includes an indication of whether the UE is to release the source cell upon receiving the second handover command. This is shown at block 930.

In some embodiments, the second handover command includes an explicit indication that the UE is to release the source cell upon receiving the second handover command. In some other embodiments, the second handover command includes an explicit indication that the UE is to keep its connection to the source cell upon receiving the second handover command.

In some embodiments, the method comprises receiving the second handover command from the second target access node before said transmitting, where the transmitting comprises forwarding the second handover command without modification. In some of these embodiments, the method comprises sending a handover request message to the second target access node prior to receiving the second handover command from the second target access node, the handover request message including an indication that the UE has not released the source cell from an ongoing DAPS handover. In others, the method comprises sending a handover request message to the second target access node prior to receiving the second handover command from the second target access node, the handover request message including an indication that the UE is to release the source cell from an ongoing DAPS handover.

In some embodiments, the method comprises receiving the second handover command from the second target cell before transmitting it, and modifying the second handover command to add the indication of whether the UE is to release the source cell upon receiving the second handover command.

In some of the embodiments discussed above, the second handover command is an RRCConnectionReconfiguration message, in an LTE network, or a RRCReconfiguration message, in an NR network. In some embodiments, the second handover command includes an indication to perform a DAPS handover to the second target cell.

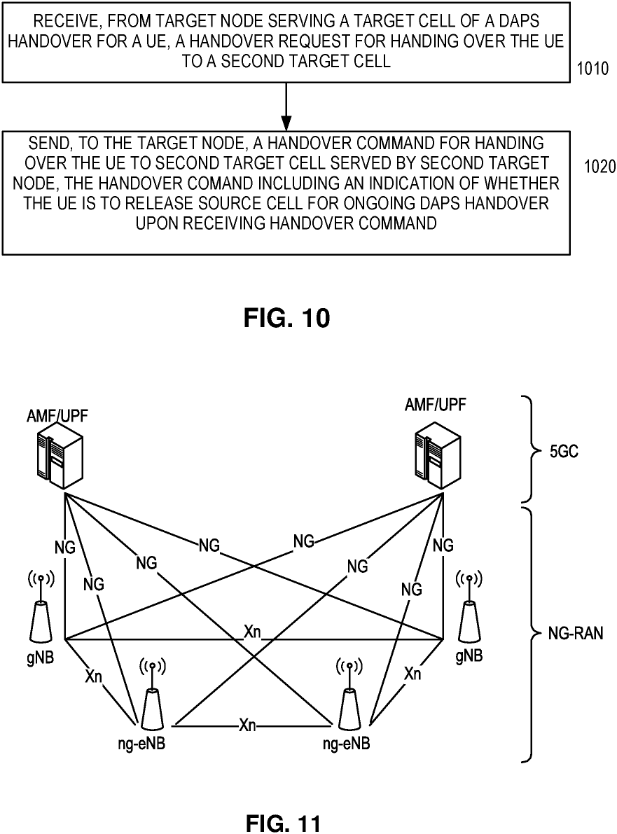

FIG. 10 illustrates a method in a second target access node of a radio access network, the method corresponding to several of the techniques described above. As shown at block 1020, the method includes the step of sending, to a first target access node, a handover command for handing over a user equipment, UE, from a first target cell served by the first target access node to a second target cell served by the second target access node. The handover command includes an indication of whether the UE is to release, upon receiving the handover command, a source cell for an ongoing dual-active protocol stack, DAPS, handover of UE from the source cell to the first target cell.

The receiving step shown in block 1020 is preceded by the step of receiving, from the first target access node, a handover request for handing over the UE to the second target cell, where sending the handover command is responsive to the handover request. In some embodiments, the handover request indicates that the UE has not released the source cell from the ongoing DAPS handover to the first target cell. In other embodiments, the handover request indicates that the UE is to release the source cell from the ongoing DAPS handover to the first target cell.

In some of the embodiments illustrated generally in FIG. 10, the handover command includes an explicit indication that the UE is to release the source cell upon receiving the handover command. In some other embodiments, the handover command includes an explicit indication that the UE is to keep its connection to the source cell upon receiving the handover command.

In some embodiments, the handover command is an RRCConnectionReconfiguration message, in an LTE network, or a RRCReconfiguration message, in an NR network. In some embodiments, the handover command includes an indication to perform a DAPS handover to the second target cell.

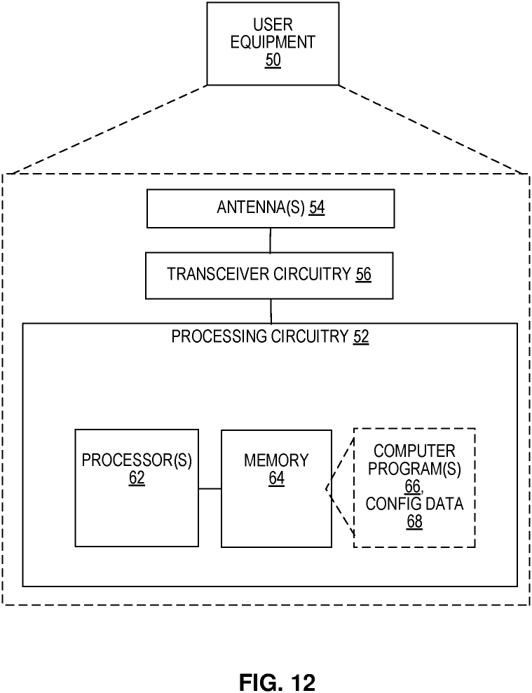

FIG. 12 illustrates a diagram of a user equipment 50 configured to carry out the techniques described above, according to some embodiments. User equipment 50 may be considered to represent any wireless devices or terminals that may operate in a network, such as a UE in a cellular network. Other examples may include a communication device, target device, MTC device, IoT device, device to device (D2D) UE, machine type UE or UE capable of machine-to-machine communication (M2M), a sensor equipped with UE, PDA (personal digital assistant), tablet, IPAD tablet, mobile terminal, smart phone, laptop embedded equipped (LEE), laptop mounted equipment (LME), USB dongles, Customer Premises Equipment (CPE), etc.

User equipment 50 is configured to communicate with a network node or base station in a wide-area cellular network via antennas 54 and transceiver circuitry 56. Transceiver circuitry 56 may include transmitter circuits, receiver circuits, and associated control circuits that are collectively configured to transmit and receive signals according to a radio access technology, for the purposes of using cellular communication services. The radio access technology can be NR or LTE, for the purposes of this discussion.

User equipment 50 also includes one or more processing circuits 52 that are operatively associated with the radio transceiver circuitry 56. Processing circuitry 52 comprises one or more digital processing circuits, e.g., one or more microprocessors, microcontrollers, DSPs, FPGAs, CPLDs, ASICs, or any mix thereof. More generally, processing circuitry 52 may comprise fixed circuitry, or programmable circuitry that is specially adapted via the execution of program instructions implementing the functionality taught herein, or may comprise some mix of fixed and programmed circuitry. Processing circuitry 52 may be multi-core.

Processing circuitry 52 also includes a memory 64. Memory 64, in some embodiments, stores one or more computer programs 66 and, optionally, configuration data 68. Memory 64 provides non-transitory storage for computer program 66 and it may comprise one or more types of computer-readable media, such as disk storage, solid-state memory storage, or any mix thereof. By way of non-limiting example, memory 64 comprises any one or more of SRAM, DRAM, EEPROM, and FLASH memory, which may be in processing circuitry 52 and/or separate from processing circuitry 52. Memory 64 may also store any configuration data 68 used by wireless device 50. Processing circuitry 52 may be configured, e.g., through the use of appropriate program code stored in memory 64, to carry out one or more of the methods and/or signaling processes detailed herein.

Processing circuitry 52 of the user equipment 50 is configured, according to some embodiments, to perform any or all of the techniques described herein for a user equipment, including those techniques illustrated in FIG. 8, and the variations described herein.

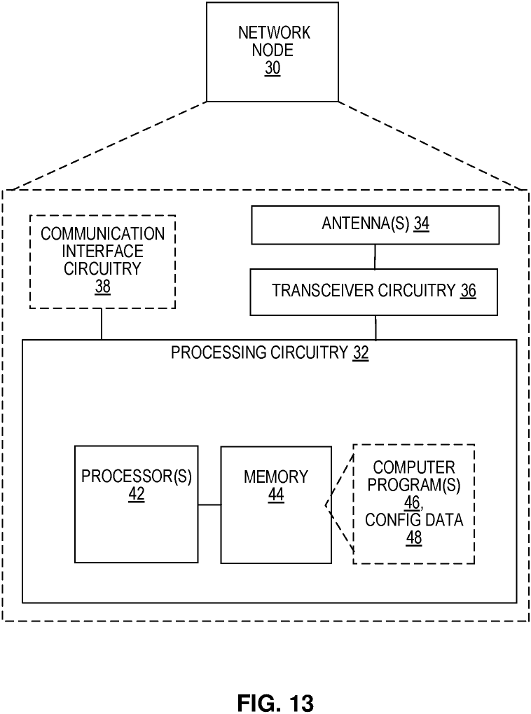

FIG. 13 shows an example network node 30 that may correspond to any of the access nodes described herein, whether acting as a target node or source node of a handover. Network node 30 may be configured to carry out one or more of these disclosed techniques. Network node 30 may be an evolved Node B (eNodeB), Node B or gNB, for example. Network node may represent a radio network node such as base station, radio base station, base transceiver station, base station controller, network controller, NR BS, Multi-cell/multicast Coordination Entity (MCE), relay node, access point, radio access point, Remote Radio Unit (RRU) Remote Radio Head (RRH), or a multi-standard BS (MSR BS).

In the discussion herein, network node 30 is described as being configured to operate as a cellular network access node in an LTE network or NR network, but network node 30 may also correspond to similar access nodes in other types of network.

Those skilled in the art will readily appreciate how each type of node may be adapted to carry out one or more of the methods and signaling processes described herein, e.g., through the modification of and/or addition of appropriate program instructions for execution by processing circuits 32.

Network node 30 facilitates communication between wireless terminals (e.g., UEs), other network access nodes and/or the core network. Network node 30 may include communication interface circuitry 38 that includes circuitry for communicating with other nodes in the core network, radio nodes, and/or other types of nodes in the network for the purposes of providing data and/or cellular communication services. Network node 30 communicates with wireless devices using antennas 34 and transceiver circuitry 36. Transceiver circuitry 36 may include transmitter circuits, receiver circuits, and associated control circuits that are collectively configured to transmit and receive signals according to a radio access technology, for the purposes of providing cellular communication services.

Network node 30 also includes one or more processing circuits 32 that are operatively associated with the transceiver circuitry 36 and, in some cases, the communication interface circuitry 38. Processing circuitry 32 comprises one or more digital processors 42, e.g., one or more microprocessors, microcontrollers, Digital Signal Processors (DSPs), Field Programmable Gate Arrays (FPGAs), Complex Programmable Logic Devices (CPLDs), Application Specific integrated Circuits (ASICs), or any mix thereof. More generally, processing circuitry 32 may comprise fixed circuitry, or programmable circuitry that is specially configured via the execution of program instructions implementing the functionality taught herein, or some mix of fixed and programmed circuitry. Processor 42 may be multi-core, i.e., having two or more processor cores utilized for enhanced performance, reduced power consumption, and more efficient simultaneous processing of multiple tasks.

Processing circuitry 32 also includes a memory 44. Memory 44, in some embodiments, stores one or more computer programs 46 and, optionally, configuration data 48. Memory 44 provides non-transitory storage for the computer program 46 and it may comprise one or more types of computer-readable media, such as disk storage, solid-state memory storage, or any mix thereof. Here, “non-transitory” means permanent, semi-permanent, or at least temporarily persistent storage and encompasses both long-term storage in non-volatile memory and storage in working memory, e.g., for program execution. By way of non-limiting example, memory 44 comprises any one or more of SRAM, DRAM, EEPROM, and FLASH memory, which may be in processing circuitry 32 and/or separate from processing circuitry 32. Memory 44 may also store any configuration data 48 used by the network access node 30. Processing circuitry 32 may be configured, e.g., through the use of appropriate program code stored in memory 44, to carry out one or more of the methods and/or signaling processes detailed hereinafter.

Processing circuitry 32 of the network node 30 is configured, according to some embodiments, to perform the techniques described herein for a network node, such as the first target node or second target node described in the several example techniques described above and illustrated in FIGS. 9 and 10.

It will be appreciated that key aspects of several of the UE-related techniques described above include:
Performing a DAPS handover from a source node to a first target node, wherein the connection to the source node is maintained while the connection to the first target node is being established.
Receiving a handover command from the first target node instructing the UE to perform a handover to a second target node, wherein the handover command is received after the connection to the first target node has been established but before the source connection has been released. In some embodiments the handover command includes an explicit indication to the UE to release the source cell connection. In some embodiments, the reception of the handover command implicitly triggers the UE to release the source cell connection. In some embodiments, the handover command includes an explicit indication to the UE to keep the source and first target cell connections.
Releasing the source and/or first target cell connection in response to the reception of the handover command.

For the first target node, key aspects of several of the techniques described herein include:
Performing a DAPS handover of a UE from a source node to the first target node, wherein the UE maintains the connection to the source node while the connection to the first target node is being established.
Sending a Handover Request message to a second target node before releasing the UE’s source cell connection. In some embodiments an indication is included in the Handover Request message which informs the second target node that a DAPS handover was recently performed and that the UE’s source cell connection is not yet released.
Receiving a handover command from the second target node which the first target node forwards to the UE. In some embodiments, the first target node modifies the handover command to also include an indication to the UE to release the source cell connection. In some other embodiments, the handover command includes an indication to the UE to release the source cell connection, wherein this indication was included in the handover command by the second target node. In some embodiments, the handover command includes an indication to the UE to keep the source and first target cell connections, wherein this indication was included in the handover command by the second target node.

For the second target nodes described herein, key aspects of several techniques include:
Receiving a Handover Request message from the target node indicating that a DAPS handover was recently performed and that the source cell connection has not yet been released.
Sending a handover command to the first target node which will be forwarded to the UE by the first target node. In some embodiments the first target node includes an indication to the UE in the handover command to release the source connection, provided that the second target node received an indication in the Handover Request message from the first target node that a DAPS handover was recently performed for the UE and that the UE’s connection in the (previous) source cell has not yet been released. In some embodiments the first target node includes an indication to the UE in the handover command to keep the source and first target connections, provided that the second target node received an indication in the Handover Request message from the first target node that a DAPS handover was recently performed for the UE and that the UE’s connection in the (previous) source cell has not yet been released

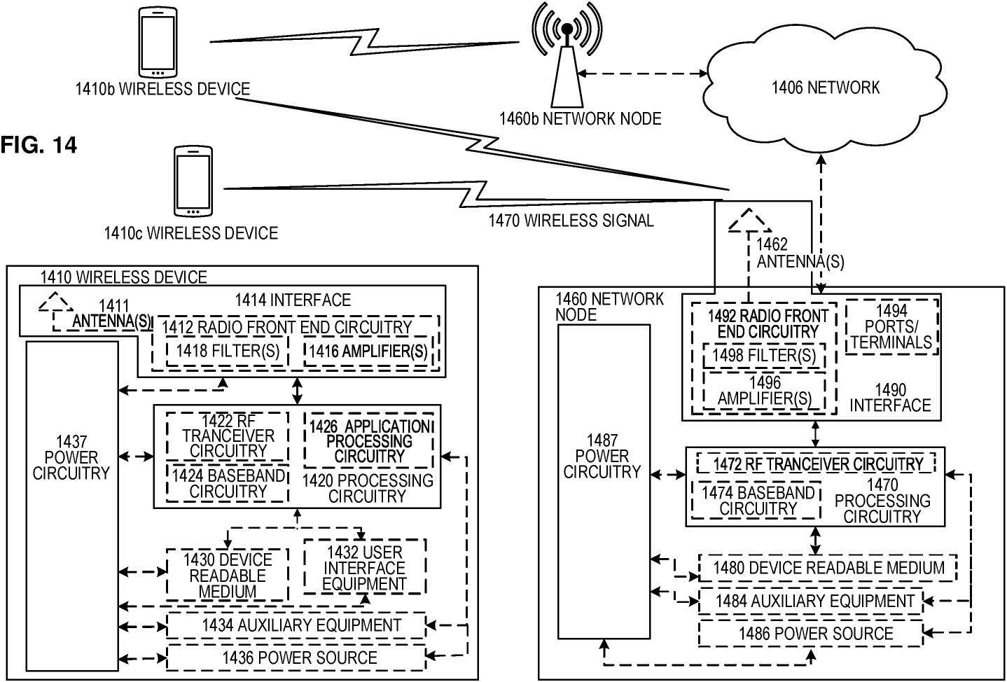

Although the subject matter described herein can be implemented in any appropriate type of system using any suitable components, the embodiments disclosed herein are described in relation to a wireless network, such as the example wireless network illustrated in FIG. 14. For simplicity, the wireless network of FIG. 14 only depicts network 1406, network nodes 1460 and 1460b, and WDs 1410, 1410b, and 1410c. In practice, a wireless network can further include any additional elements suitable to support communication between wireless devices or between a wireless device and another communication device, such as a landline telephone, a service provider, or any other network node or end device. Of the illustrated components, network node 1460 and wireless device (WD) 1410 are depicted with additional detail. The wireless network can provide communication and other types of services to one or more wireless devices to facilitate the wireless devices’ access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1406 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1460 and WD 1410 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 14, network node 1460 includes processing circuitry 1470, device readable medium 1480, interface 1490, auxiliary equipment 1484, power source 1486, power circuitry 1487, and antenna 1462. Although network node 1460 illustrated in the example wireless network of FIG. 14 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 1460 are depicted as single boxes located within a larger box, or nested within multiple boxes, in practice, a network node can comprise multiple different physical components that make up a single illustrated component (e.g., device readable medium 1480 can comprise multiple separate hard drives as well as multiple RAM modules).

Similarly, network node 1460 can be composed of multiple physically separate components (e.g., a NodeB component and a RNC component, or a BTS component and a BSC component, etc.), which can each have their own respective components. In certain scenarios in which network node 1460 comprises multiple separate components (e.g., BTS and BSC components), one or more of the separate components can be shared among several network nodes. For example, a single RNC can control multiple NodeBs. In such a scenario, each unique NodeB and RNC pair, can in some instances be considered a single separate network node. In some embodiments, network node 1460 can be configured to support multiple radio access technologies (RATs). In such embodiments, some components can be duplicated (e.g., separate device readable medium 1480 for the different RATs) and some components can be reused (e.g., the same antenna 1462 can be shared by the RATs). Network node 1460 can also include multiple sets of the various illustrated components for different wireless technologies integrated into network node 1460, such as, for example, GSM, WCDMA, LTE, NR, WiFi, or Bluetooth wireless technologies. These wireless technologies can be integrated into the same or different chip or set of chips and other components within network node 1460.

Processing circuitry 1470 can be configured to perform any determining, calculating, or similar operations (e.g., certain obtaining operations) described herein as being provided by a network node. These operations performed by processing circuitry 1470 can include processing information obtained by processing circuitry 1470 by, for example, converting the obtained information into other information, comparing the obtained information or converted information to information stored in the network node, and/or performing one or more operations based on the obtained information or converted information, and as a result of said processing making a determination.

Processing circuitry 1470 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1460 components, such as device readable medium 1480, network node 1460 functionality. For example, processing circuitry 1470 can execute instructions stored in device readable medium 1480 or in memory within processing circuitry 1470. Such functionality can include providing any of the various wireless features, functions, or benefits discussed herein. In some embodiments, processing circuitry 1470 can include a system on a chip (SOC).

In some embodiments, processing circuitry 1470 can include one or more of radio frequency (RF) transceiver circuitry 1472 and baseband processing circuitry 1474. In some embodiments, radio frequency (RF) transceiver circuitry 1472 and baseband processing circuitry 1474 can be on separate chips (or sets of chips), boards, or units, such as radio units and digital units. In alternative embodiments, part or all of RF transceiver circuitry 1472 and baseband processing circuitry 1474 can be on the same chip or set of chips, boards, or units

In certain embodiments, some or all of the functionality described herein as being provided by a network node, base station, eNB or other such network device can be performed by processing circuitry 1470 executing instructions stored on device readable medium 1480 or memory within processing circuitry 1470. In alternative embodiments, some or all of the functionality can be provided by processing circuitry 1470 without executing instructions stored on a separate or discrete device readable medium, such as in a hard-wired manner. In any of those embodiments, whether executing instructions stored on a device readable storage medium or not, processing circuitry 1470 can be configured to perform the described functionality. The benefits provided by such functionality are not limited to processing circuitry 1470 alone or to other components of network node 1460, but are enjoyed by network node 1460 as a whole, and/or by end users and the wireless network generally.

Device readable medium 1480 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 1470. Device readable medium 1480 can store any suitable instructions, data or information, including a computer program, software, an application including one or more of logic, rules, code, tables, etc. and/or other instructions capable of being executed by processing circuitry 1470 and, utilized by network node 1460. Device readable medium 1480 can be used to store any calculations made by processing circuitry 1470 and/or any data received via interface 1490. In some embodiments, processing circuitry 1470 and device readable medium 1480 can be considered to be integrated.

Interface 1490 is used in the wired or wireless communication of signalling and/or data between network node 1460, network 1406, and/or WDs 1410. As illustrated, interface 1490 comprises port(s)/terminal(s) 1494 to send and receive data, for example to and from network 1406 over a wired connection. Interface 1490 also includes radio front end circuitry 1492 that can be coupled to, or in certain embodiments a part of, antenna 1462. Radio front end circuitry 1492 comprises filters 1498 and amplifiers 1496. Radio front end circuitry 1492 can be connected to antenna 1462 and processing circuitry 1470. Radio front end circuitry can be configured to condition signals communicated between antenna 1462 and processing circuitry 1470. Radio front end circuitry 1492 can receive digital data that is to be sent out to other network nodes or WDs via a wireless connection. Radio front end circuitry 1492 can convert the digital data into a radio signal having the appropriate channel and bandwidth parameters using a combination of filters 1498 and/or amplifiers 1496. The radio signal can then be transmitted via antenna 1462. Similarly, when receiving data, antenna 1462 can collect radio signals which are then converted into digital data by radio front end circuitry 1492. The digital data can be passed to processing circuitry 1470. In other embodiments, the interface can comprise different components and/or different combinations of components.

In certain alternative embodiments, network node 1460 may not include separate radio front end circuitry 1492, instead, processing circuitry 1470 can comprise radio front end circuitry and can be connected to antenna 1462 without separate radio front end circuitry 1492. Similarly, in some embodiments, all or some of RF transceiver circuitry 1472 can be considered a part of interface 1490. In still other embodiments, interface 1490 can include one or more ports or terminals 1494, radio front end circuitry 1492, and RF transceiver circuitry 1472, as part of a radio unit (not shown), and interface 1490 can communicate with baseband processing circuitry 1474, which is part of a digital unit (not shown).

Antenna 1462 can include one or more antennas, or antenna arrays, configured to send and/or receive wireless signals. Antenna 1462 can be coupled to radio front end circuitry 1490 and can be any type of antenna capable of transmitting and receiving data and/or signals wirelessly. In some embodiments, antenna 1462 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line-of-sight antenna used to transmit/receive radio signals in a relatively straight line. In some instances, the use of more than one antenna can be referred to as MIMO. In certain embodiments, antenna 1462 can be separate from network node 1460 and can be connectable to network node 1460 through an interface or port.

Antenna 1462, interface 1490, and/or processing circuitry 1470 can be configured to perform any receiving operations and/or certain obtaining operations described herein as being performed by a network node. Any information, data and/or signals can be received from a wireless device, another network node and/or any other network equipment. Similarly, antenna 1462, interface 1490, and/or processing circuitry 1470 can be configured to perform any transmitting operations described herein as being performed by a network node. Any information, data and/or signals can be transmitted to a wireless device, another network node and/or any other network equipment.

Power circuitry 1487 can comprise, or be coupled to, power management circuitry and can be configured to supply the components of network node 1460 with power for performing the functionality described herein. Power circuitry 1487 can receive power from power source 1486. Power source 1486 and/or power circuitry 1487 can be configured to provide power to the various components of network node 1460 in a form suitable for the respective components (e.g., at a voltage and current level needed for each respective component). Power source 1486 can either be included in, or external to, power circuitry 1487 and/or network node 1460. For example, network node 1460 can be connectable to an external power source (e.g., an electricity outlet) via an input circuitry or interface such as an electrical cable, whereby the external power source supplies power to power circuitry 1487. As a further example, power source 1486 can comprise a source of power in the form of a battery or battery pack which is connected to, or integrated in, power circuitry 1487. The battery can provide backup power should the external power source fail. Other types of power sources, such as photovoltaic devices, can also be used.

Alternative embodiments of network node 1460 can include additional components beyond those shown in FIG. 14 that can be responsible for providing certain aspects of the network node’s functionality, including any of the functionality described herein and/or any functionality necessary to support the subject matter described herein. For example, network node 1460 can include user interface equipment to allow and/or facilitate input of information into network node 1460 and to allow and/or facilitate output of information from network node 1460. This can allow and/or facilitate a user to perform diagnostic, maintenance, repair, and other administrative functions for network node 1460.

In some embodiments, a wireless device (WD, e.g. WD 1410) can be configured to communicate wirelessly with network nodes (e.g., 1460) and/or other wireless devices (e.g., 1410b,c). Communicating wirelessly can involve transmitting and/or receiving wireless signals using electromagnetic waves, radio waves, infrared waves, and/or other types of signals suitable for conveying information through air. In some embodiments, a WD can be configured to transmit and/or receive information without direct human interaction. For instance, a WD can be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements, and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 1410 includes antenna 1411, interface 1414, processing circuitry 1420, device readable medium 1430, user interface equipment 1432, auxiliary equipment 1434, power source 1436 and power circuitry 1437. WD 1410 can include multiple sets of one or more of the illustrated components for different wireless technologies supported by WD 1410, such as, for example, GSM, WCDMA, LTE, NR, WiFi, WiMAX, or Bluetooth wireless technologies, just to mention a few. These wireless technologies can be integrated into the same or different chips or set of chips as other components within WD 1410.

Antenna 1411 can include one or more antennas or antenna arrays, configured to send and/or receive wireless signals, and is connected to interface 1414. In certain alternative embodiments, antenna 1411 can be separate from WD 1410 and be connectable to WD 1410 through an interface or port. Antenna 1411, interface 1414, and/or processing circuitry 1420 can be configured to perform any receiving or transmitting operations described herein as being performed by a WD. Any information, data and/or signals can be received from a network node and/or another WD. In some embodiments, radio front end circuitry and/or antenna 1411 can be considered an interface.

As illustrated, interface 1414 comprises radio front end circuitry 1412 and antenna 1411. Radio front end circuitry 1412 comprise one or more filters 1418 and amplifiers 1416. Radio front end circuitry 1414 is connected to antenna 1411 and processing circuitry 1420, and can be configured to condition signals communicated between antenna 1411 and processing circuitry 1420. Radio front end circuitry 1412 can be coupled to or a part of antenna 1411. In some embodiments, WD 1410 may not include separate radio front end circuitry 1412; rather, processing circuitry 1420 can comprise radio front end circuitry and can be connected to antenna 1411. Similarly, in some embodiments, some or all of RF transceiver circuitry 1422 can be considered a part of interface 1414. Radio front end circuitry 1412 can receive digital data that is to be sent out to other network nodes or WDs via a wireless connection. Radio front end circuitry 1412 can convert the digital data into a radio signal having the appropriate channel and bandwidth parameters using a combination of filters 1418 and/or amplifiers 1416. The radio signal can then be transmitted via antenna 1411. Similarly, when receiving data, antenna 1411 can collect radio signals which are then converted into digital data by radio front end circuitry 1412. The digital data can be passed to processing circuitry 1420. In other embodiments, the interface can comprise different components and/or different combinations of components.

Processing circuitry 1420 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1410 components, such as device readable medium 1430, WD 1410 functionality. Such functionality can include providing any of the various wireless features or benefits discussed herein. For example, processing circuitry 1420 can execute instructions stored in device readable medium 1430 or in memory within processing circuitry 1420 to provide the functionality disclosed herein.

As illustrated, processing circuitry 1420 includes one or more of RF transceiver circuitry 1422, baseband processing circuitry 1424, and application processing circuitry 1426. In other embodiments, the processing circuitry can comprise different components and/or different combinations of components. In certain embodiments processing circuitry 1420 of WD 1410 can comprise a SOC. In some embodiments, RF transceiver circuitry 1422, baseband processing circuitry 1424, and application processing circuitry 1426 can be on separate chips or sets of chips. In alternative embodiments, part or all of baseband processing circuitry 1424 and application processing circuitry 1426 can be combined into one chip or set of chips, and RF transceiver circuitry 1422 can be on a separate chip or set of chips. In still alternative embodiments, part or all of RF transceiver circuitry 1422 and baseband processing circuitry 1424 can be on the same chip or set of chips, and application processing circuitry 1426 can be on a separate chip or set of chips. In yet other alternative embodiments, part or all of RF transceiver circuitry 1422, baseband processing circuitry 1424, and application processing circuitry 1426 can be combined in the same chip or set of chips. In some embodiments, RF transceiver circuitry 1422 can be a part of interface 1414. RF transceiver circuitry 1422 can condition RF signals for processing circuitry 1420.

In certain embodiments, some or all of the functionality described herein as being performed by a WD can be provided by processing circuitry 1420 executing instructions stored on device readable medium 1430, which in certain embodiments can be a computer-readable storage medium. In alternative embodiments, some or all of the functionality can be provided by processing circuitry 1420 without executing instructions stored on a separate or discrete device readable storage medium, such as in a hard-wired manner. In any of those particular embodiments, whether executing instructions stored on a device readable storage medium or not, processing circuitry 1420 can be configured to perform the described functionality. The benefits provided by such functionality are not limited to processing circuitry 1420 alone or to other components of WD 1410, but are enjoyed by WD 1410 as a whole, and/or by end users and the wireless network generally.

Processing circuitry 1420 can be configured to perform any determining, calculating, or similar operations (e.g., certain obtaining operations) described herein as being performed by a WD. These operations, as performed by processing circuitry 1420, can include processing information obtained by processing circuitry 1420 by, for example, converting the obtained information into other information, comparing the obtained information or converted information to information stored by WD 1410, and/or performing one or more operations based on the obtained information or converted information, and as a result of said processing making a determination.

Device readable medium 1430 can be operable to store a computer program, software, an application including one or more of logic, rules, code, tables, etc. and/or other instructions capable of being executed by processing circuitry 1420. Device readable medium 1430 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 1420. In some embodiments, processing circuitry 1420 and device readable medium 1430 can be considered to be integrated.

User interface equipment 1432 can include components that allow and/or facilitate a human user to interact with WD 1410. Such interaction can be of many forms, such as visual, audial, tactile, etc. User interface equipment 1432 can be operable to produce output to the user and to allow and/or facilitate the user to provide input to WD 1410. The type of interaction can vary depending on the type of user interface equipment 1432 installed in WD 1410. For example, if WD 1410 is a smart phone, the interaction can be via a touch screen; if WD 1410 is a smart meter, the interaction can be through a screen that provides usage (e.g., the number of gallons used) or a speaker that provides an audible alert (e.g., if smoke is detected). User interface equipment 1432 can include input interfaces, devices and circuits, and output interfaces, devices and circuits. User interface equipment 1432 can be configured to allow and/or facilitate input of information into WD 1410, and is connected to processing circuitry 1420 to allow and/or facilitate processing circuitry 1420 to process the input information. User interface equipment 1432 can include, for example, a microphone, a proximity or other sensor, keys/buttons, a touch display, one or more cameras, a USB port, or other input circuitry. User interface equipment 1432 is also configured to allow and/or facilitate output of information from WD 1410, and to allow and/or facilitate processing circuitry 1420 to output information from WD 1410. User interface equipment 1432 can include, for example, a speaker, a display, vibrating circuitry, a USB port, a headphone interface, or other output circuitry. Using one or more input and output interfaces, devices, and circuits, of user interface equipment 1432, WD 1410 can communicate with end users and/or the wireless network, and allow and/or facilitate them to benefit from the functionality described herein.

Auxiliary equipment 1434 is operable to provide more specific functionality which may not be generally performed by WDs. This can comprise specialized sensors for doing measurements for various purposes, interfaces for additional types of communication such as wired communications etc. The inclusion and type of components of auxiliary equipment 1434 can vary depending on the embodiment and/or scenario.

Power source 1436 can, in some embodiments, be in the form of a battery or battery pack. Other types of power sources, such as an external power source (e.g., an electricity outlet), photovoltaic devices or power cells, can also be used. WD 1410 can further comprise power circuitry 1437 for delivering power from power source 1436 to the various parts of WD 1410 which need power from power source 1436 to carry out any functionality described or indicated herein. Power circuitry 1437 can in certain embodiments comprise power management circuitry. Power circuitry 1437 can additionally or alternatively be operable to receive power from an external power source; in which case WD 1410 can be connectable to the external power source (such as an electricity outlet) via input circuitry or an interface such as an electrical power cable. Power circuitry 1437 can also in certain embodiments be operable to deliver power from an external power source to power source 1436. This can be, for example, for the charging of power source 1436. Power circuitry 1437 can perform any converting or other modification to the power from power source 1436 to make it suitable for supply to the respective components of WD 1410.

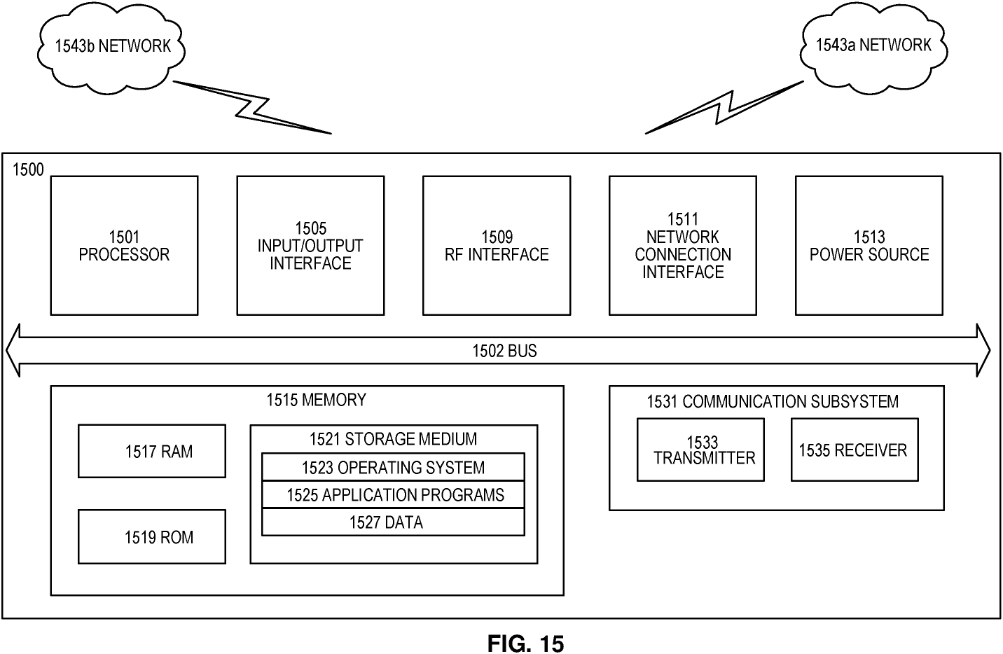

FIG. 15 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 1500 can be any UE identified by the 3rd Generation Partnership Project (3GPP), including a NB-IoT UE, a machine type communication (MTC) UE, and/or an enhanced MTC (eMTC) UE. UE 1500, as illustrated in FIG. 15, is one example of a WD configured for communication in accordance with one or more communication standards promulgated by the 3rd Generation Partnership Project (3GPP), such as 3GPP’s GSM, UMTS, LTE, and/or 5G standards. As mentioned previously, the term WD and UE can be used interchangeable. Accordingly, although FIG. 15 is a UE, the components discussed herein are equally applicable to a WD, and vice-versa.

In FIG. 15, UE 1500 includes processing circuitry 1501 that is operatively coupled to input/output interface 1505, radio frequency (RF) interface 1509, network connection interface 1511, memory 1515 including random access memory (RAM) 917, read-only memory (ROM) 919, and storage medium 921 or the like, communication subsystem 931, power source 933, and/or any other component, or any combination thereof. Storage medium 1521 includes operating system 1523, application program 1525, and data 1527. In other embodiments, storage medium 1521 can include other similar types of information. Certain UEs can utilize all of the components shown in FIG. 15, or only a subset of the components. The level of integration between the components can vary from one UE to another UE. Further, certain UEs can contain multiple instances of a component, such as multiple processors, memories, transceivers, transmitters, receivers, etc.

In FIG. 15, processing circuitry 1501 can be configured to process computer instructions and data. Processing circuitry 1501 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1501 can include two central processing units (CPUs). Data can be information in a form suitable for use by a computer.

In the depicted embodiment, input/output interface 1505 can be configured to provide a communication interface to an input device, output device, or input and output device. UE 1500 can be configured to use an output device via input/output interface 1505. An output device can use the same type of interface port as an input device. For example, a USB port can be used to provide input to and output from UE 1500. The output device can be a speaker, a sound card, a video card, a display, a monitor, a printer, an actuator, an emitter, a smartcard, another output device, or any combination thereof. UE 1500 can be configured to use an input device via input/output interface 1505 to allow and/or facilitate a user to capture information into UE 1500. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 15, RF interface 1509 can be configured to provide a communication interface to RF components such as a transmitter, a receiver, and an antenna. Network connection interface 1511 can be configured to provide a communication interface to network 1543a. Network 1543a can encompass wired and/or wireless networks such as a local-area network (LAN), a wide-area network (WAN), a computer network, a wireless network, a telecommunications network, another like network or any combination thereof. For example, network 1543a can comprise a Wi-Fi network. Network connection interface 1511 can be configured to include a receiver and a transmitter interface used to communicate with one or more other devices over a communication network according to one or more communication protocols, such as Ethernet, TCP/IP, SONET, ATM, or the like. Network connection interface 1511 can implement receiver and transmitter functionality appropriate to the communication network links (e.g., optical, electrical, and the like). The transmitter and receiver functions can share circuit components, software or firmware, or alternatively can be implemented separately.

RAM 1517 can be configured to interface via bus 1502 to processing circuitry 1501 to provide storage or caching of data or computer instructions during the execution of software programs such as the operating system, application programs, and device drivers. ROM 1519 can be configured to provide computer instructions or data to processing circuitry 1501. For example, ROM 1519 can be configured to store invariant low-level system code or data for basic system functions such as basic input and output (I/O), startup, or reception of keystrokes from a keyboard that are stored in a non-volatile memory. Storage medium 1521 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1521 can be configured to include operating system 1523, application program 1525 such as a web browser application, a widget or gadget engine or another application, and data file 1527. Storage medium 1521 can store, for use by UE 1500, any of a variety of various operating systems or combinations of operating systems.

Storage medium 1521 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1521 can allow and/or facilitate UE 1500 to access computer-executable instructions, application programs or the like, stored on transitory or non-transitory memory media, to off-load data, or to upload data. An article of manufacture, such as one utilizing a communication system can be tangibly embodied in storage medium 1521, which can comprise a device readable medium.

In FIG. 15, processing circuitry 1501 can be configured to communicate with network 1543b using communication subsystem 1531. Network 1543a and network 1543b can be the same network or networks or different network or networks. Communication subsystem 1531 can be configured to include one or more transceivers used to communicate with network 1543b. For example, communication subsystem 1531 can be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver can include transmitter 1533 and/or receiver 1535 to implement transmitter or receiver functionality, respectively, appropriate to the RAN links (e.g., frequency allocations and the like). Further, transmitter 1533 and receiver 1535 of each transceiver can share circuit components, software or firmware, or alternatively can be implemented separately.

In the illustrated embodiment, the communication functions of communication subsystem 1531 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 1531 can include cellular communication, Wi-Fi communication, Bluetooth communication, and GPS communication. Network 1543b can encompass wired and/or wireless networks such as a local-area network (LAN), a wide-area network (WAN), a computer network, a wireless network, a telecommunications network, another like network or any combination thereof. For example, network 1543b can be a cellular network, a Wi-Fi network, and/or a near-field network. Power source 1513 can be configured to provide alternating current (AC) or direct current (DC) power to components of UE 1500.

The features, benefits and/or functions described herein can be implemented in one of the components of UE 1500 or partitioned across multiple components of UE 1500. Further, the features, benefits, and/or functions described herein can be implemented in any combination of hardware, software or firmware. In one example, communication subsystem 1531 can be configured to include any of the components described herein. Further, processing circuitry 1501 can be configured to communicate with any of such components over bus 1502. In another example, any of such components can be represented by program instructions stored in memory that when executed by processing circuitry 1501 perform the corresponding functions described herein. In another example, the functionality of any of such components can be partitioned between processing circuitry 1501 and communication subsystem 1531. In another example, the non-computationally intensive functions of any of such components can be implemented in software or firmware and the computationally intensive functions can be implemented in hardware.

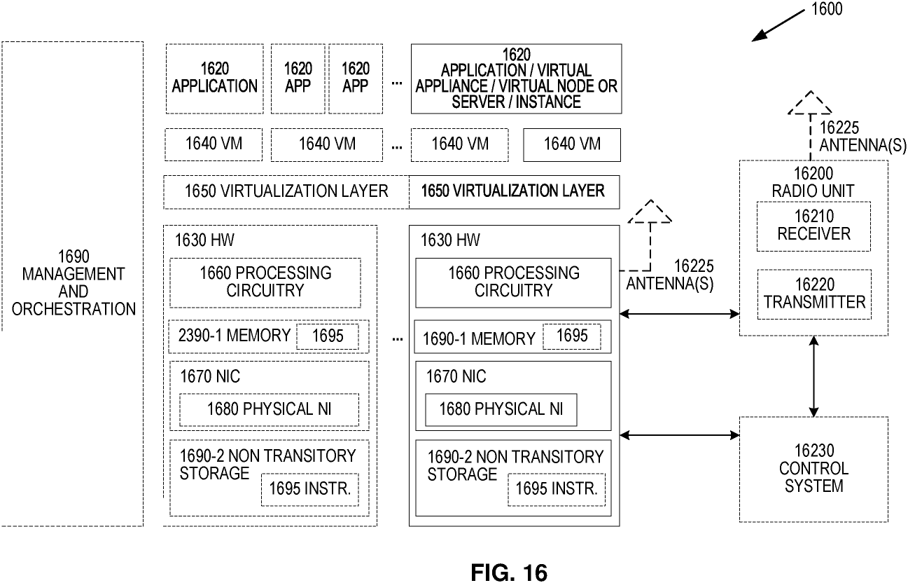

FIG. 16 is a schematic block diagram illustrating a virtualization environment 1600 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station, a virtualized radio access node, virtualized core network node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 1600 hosted by one or more of hardware nodes 1630. Further, in embodiments in which the virtual node is not a radio access node or does not require radio connectivity (e.g., a core network node), then the network node can be entirely virtualized.

The functions can be implemented by one or more applications 1620 (which can alternatively be called software instances, virtual appliances, network functions, virtual nodes, virtual network functions, etc.) operative to implement some of the features, functions, and/or benefits of some of the embodiments disclosed herein. Applications 1620 are run in virtualization environment 1600 which provides hardware 1630 comprising processing circuitry 1660 and memory 1690. Memory 1690 contains instructions 1695 executable by processing circuitry 1660 whereby application 1620 is operative to provide one or more of the features, benefits, and/or functions disclosed herein.

Virtualization environment 1600, comprises general-purpose or special-purpose network hardware devices 1630 comprising a set of one or more processors or processing circuitry 1660, which can be commercial off-the-shelf (COTS) processors, dedicated Application Specific Integrated Circuits (ASICs), or any other type of processing circuitry including digital or analog hardware components or special purpose processors. Each hardware device can comprise memory 1690-1 which can be non-persistent memory for temporarily storing instructions 1695 or software executed by processing circuitry 1660. Each hardware device can comprise one or more network interface controllers (NICs) 1670, also known as network interface cards, which include physical network interface 1680. Each hardware device can also include non-transitory, persistent, machine-readable storage media 1690-2 having stored therein software 1695 and/or instructions executable by processing circuitry 1660. Software 1695 can include any type of software including software for instantiating one or more virtualization layers 1650 (also referred to as hypervisors), software to execute virtual machines 1640 as well as software allowing it to execute functions, features and/or benefits described in relation with some embodiments described herein.

Virtual machines 1640, comprise virtual processing, virtual memory, virtual networking or interface and virtual storage, and can be run by a corresponding virtualization layer 1650 or hypervisor. Different embodiments of the instance of virtual appliance 1620 can be implemented on one or more of virtual machines 1640, and the implementations can be made in different ways.

During operation, processing circuitry 1660 executes software 1695 to instantiate the hypervisor or virtualization layer 1650, which can sometimes be referred to as a virtual machine monitor (VMM). Virtualization layer 1650 can present a virtual operating platform that appears like networking hardware to virtual machine 1640.

As shown in FIG. 16, hardware 1630 can be a standalone network node with generic or specific components. Hardware 1630 can comprise antenna 16225 and can implement some functions via virtualization. Alternatively, hardware 1630 can be part of a larger cluster of hardware (e.g., such as in a data center or customer premise equipment (CPE)) where many hardware nodes work together and are managed via management and orchestration (MANO) 1690, which, among others, oversees lifecycle management of applications 1620.

Virtualization of the hardware is in some contexts referred to as network function virtualization (NFV). NFV can be used to consolidate many network equipment types onto industry standard high volume server hardware, physical switches, and physical storage, which can be located in data centers, and customer premise equipment.

In the context of NFV, virtual machine 1640 can be a software implementation of a physical machine that runs programs as if they were executing on a physical, non-virtualized machine. Each of virtual machines 1640, and that part of hardware 1630 that executes that virtual machine, be it hardware dedicated to that virtual machine and/or hardware shared by that virtual machine with others of the virtual machines 1640, forms a separate virtual network elements (VNE).

In the context of NFV, Virtual Network Function (VNF) is responsible for handling specific network functions that run in one or more virtual machines 1640 on top of hardware networking infrastructure 1630, and can correspond to application 1620 in FIG. 16.

In some embodiments, one or more radio units 16200 that each include one or more transmitters 16220 and one or more receivers 16210 can be coupled to one or more antennas 16225. Radio units 16200 can communicate directly with hardware nodes 1630 via one or more appropriate network interfaces and can be used in combination with the virtual components to provide a virtual node with radio capabilities, such as a radio access node or a base station.

In some embodiments, some signaling can be affected with the use of control system 16230 which can alternatively be used for communication between the hardware nodes 1630 and radio units 16200.

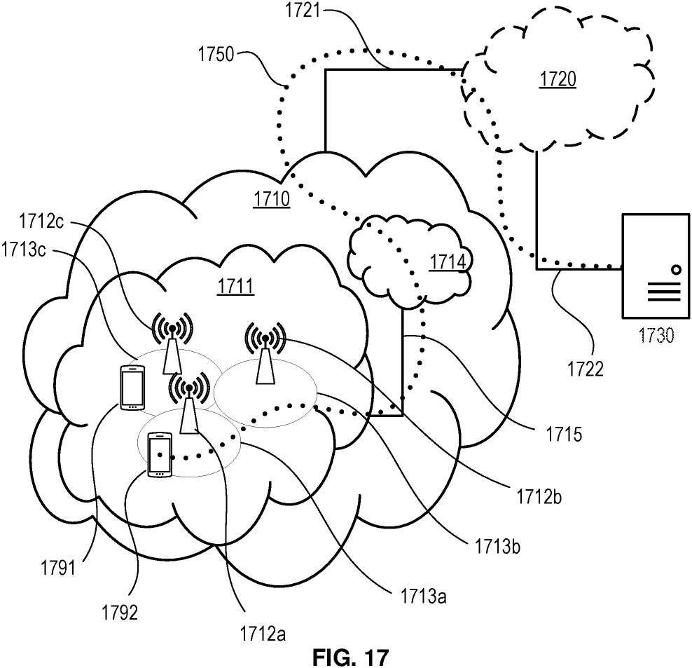

With reference to FIG. 17, in accordance with an embodiment, a communication system includes telecommunication network 1710, such as a 3GPP-type cellular network, which comprises access network 1711, such as a radio access network, and core network 1714. Access network 1711 comprises a plurality of base stations 1712a, 1712b, 1712c, such as NBs, eNBs, gNBs or other types of wireless access points, each defining a corresponding coverage area 1713a, 1713b, 1713c. Each base station 1712a, 1712b, 1712c is connectable to core network 1714 over a wired or wireless connection 1715. A first UE 1791 located in coverage area 1713c can be configured to wirelessly connect to, or be paged by, the corresponding base station 1712c. A second UE 1792 in coverage area 1713a is wirelessly connectable to the corresponding base station 1712a. While a plurality of UEs 1791, 1792 are illustrated in this example, the disclosed embodiments are equally applicable to a situation where a sole UE is in the coverage area or where a sole UE is connecting to the

Telecommunication network 1710 is itself connected to host computer 1730, which can be embodied in the hardware and/or software of a standalone server, a cloud-implemented server, a distributed server or as processing resources in a server farm. Host computer 1730 can be under the ownership or control of a service provider, or can be operated by the service provider or on behalf of the service provider. Connections 1721 and 1722 between telecommunication network 1710 and host computer 1730 can extend directly from core network 1714 to host computer 1730 or can go via an optional intermediate network 1720. Intermediate network 1720 can be one of, or a combination of more than one of, a public, private or hosted network; intermediate network 1720, if any, can be a backbone network or the Internet; in particular, intermediate network 1720 can comprise two or more sub-networks (not shown).

The communication system of FIG. 17 as a whole enables connectivity between the connected UEs 1791, 1792 and host computer 1730. The connectivity can be described as an over-the-top (OTT) connection 1750. Host computer 1730 and the connected UEs 1791, 1792 are configured to communicate data and/or signaling via OTT connection 1750, using access network 1711, core network 1714, any intermediate network 1720 and possible further infrastructure (not shown) as intermediaries. OTT connection 1750 can be transparent in the sense that the participating communication devices through which OTT connection 1750 passes are unaware of routing of uplink and downlink communications. For example, base station 1712 may not or need not be informed about the past routing of an incoming downlink communication with data originating from host computer 1730 to be forwarded (e.g., handed over) to a connected UE 1791. Similarly, base station 1712 need not be aware of the future routing of an outgoing uplink communication originating from the UE 1791 towards the host computer 1730.

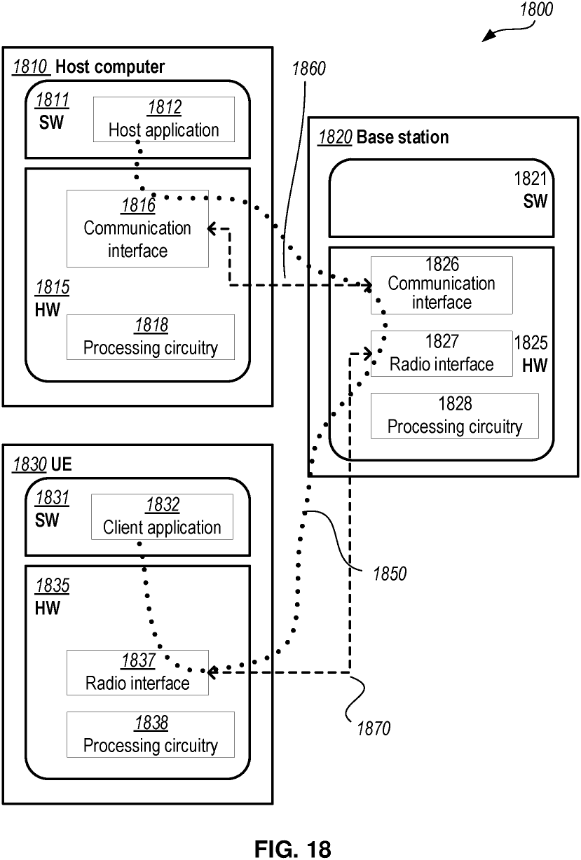

Example implementations, in accordance with an embodiment, of the UE, base station and host computer discussed in the preceding paragraphs will now be described with reference to FIG. 18. In communication system 1800, host computer 1810 comprises hardware 1815 including communication interface 1816 configured to set up and maintain a wired or wireless connection with an interface of a different communication device of communication system 1800. Host computer 1810 further comprises processing circuitry 1818, which can have storage and/or processing capabilities. In particular, processing circuitry 1818 can comprise one or more programmable processors, application-specific integrated circuits, field programmable gate arrays or combinations of these (not shown) adapted to execute instructions. Host computer 1810 further comprises software 1811, which is stored in or accessible by host computer 1810 and executable by processing circuitry 1818. Software 1811 includes host application 1812. Host application 1812 can be operable to provide a service to a remote user, such as UE 1830 connecting via OTT connection 1850 terminating at UE 1830 and host computer 1810. In providing the service to the remote user, host application 1812 can provide user data which is transmitted using OTT connection 1850.

Communication system 1800 can also include base station 1820 provided in a telecommunication system and comprising hardware 1825 enabling it to communicate with host computer 1810 and with UE 1830. Hardware 1825 can include communication interface 1826 for setting up and maintaining a wired or wireless connection with an interface of a different communication device of communication system 1800, as well as radio interface 1827 for setting up and maintaining at least wireless connection 1870 with UE 1830 located in a coverage area (not shown in FIG. 18) served by base station 1820.

Communication interface 1826 can be configured to facilitate connection 1860 to host computer 1810. Connection 1860 can be direct or it can pass through a core network (not shown in FIG. 18) of the telecommunication system and/or through one or more intermediate networks outside the telecommunication system. In the embodiment shown, hardware 1825 of base station 1820 can also include processing circuitry 1828, which can comprise one or more programmable processors, application-specific integrated circuits, field programmable gate arrays or combinations of these (not shown) adapted to execute instructions. Base station 1820 further has software 1821 stored internally or accessible via an external connection.

Communication system 1800 can also include UE 1830 already referred to. Its hardware 1835 can include radio interface 1837 configured to set up and maintain wireless connection 1870 with a base station serving a coverage area in which UE 1830 is currently located. Hardware 1835 of UE 1830 can also include processing circuitry 1838, which can comprise one or more programmable processors, application-specific integrated circuits, field programmable gate arrays or combinations of these (not shown) adapted to execute instructions. UE 1830 further comprises software 1831, which is stored in or accessible by UE 1830 and executable by processing circuitry 1838. Software 1831 includes client application 1832. Client application 1832 can be operable to provide a service to a human or non-human user via UE 1830, with the support of host computer 1810. In host computer 1810, an executing host application 1812 can communicate with the executing client application 1832 via OTT connection 1850 terminating at UE 1830 and host computer 1810. In providing the service to the user, client application 1832 can receive request data from host application 1812 and provide user data in response to the request data. OTT connection 1850 can transfer both the request data and the user data. Client application 1832 can interact with the user to generate the user data that it provides.

It is noted that host computer 1810, base station 1820 and UE 1830 illustrated in FIG. 18 can be similar or identical to host computer 1730, one of base stations 1712a, 1712b, 1712c and one of UEs 1791, 1792 of FIG. 17, respectively. This is to say, the inner workings of these entities can be as shown in FIG. 18 and independently, the surrounding network topology can be that of FIG. 17.

In FIG. 18, OTT connection 1850 has been drawn abstractly to illustrate the communication between host computer 1810 and UE 1830 via base station 1820, without explicit reference to any intermediary devices and the precise routing of messages via these devices. Network infrastructure can determine the routing, which it can be configured to hide from UE 1830 or from the service provider operating host computer 1810, or both. While OTT connection 1850 is active, the network infrastructure can further take decisions by which it dynamically changes the routing (e.g., on the basis of load balancing consideration or reconfiguration of the network).

Wireless connection 1870 between UE 1830 and base station 1820 is in accordance with the teachings of the embodiments described throughout this disclosure. One or more of the various embodiments improve the performance of OTT services provided to UE 1830 using OTT connection 1850, in which wireless connection 1870 forms the last segment. More precisely, the exemplary embodiments disclosed herein can improve flexibility for the network to monitor end-to-end quality-of-service (QoS) of data flows, including their corresponding radio bearers, associated with data sessions between a user equipment (UE) and another entity, such as an OTT data application or service external to the 5G network. These and other advantages can facilitate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 1850 between host computer 1810 and UE 1830, in response to variations in the measurement results. The measurement procedure and/or the network functionality for reconfiguring OTT connection 1850 can be implemented in software 1811 and hardware 1815 of host computer 1810 or in software 1831 and hardware 1835 of UE 1830, or both. In embodiments, sensors (not shown) can be deployed in or in association with communication devices through which OTT connection 1850 passes; the sensors can participate in the measurement procedure by supplying values of the monitored quantities exemplified above, or supplying values of other physical quantities from which software 1811, 1831 can compute or estimate the monitored quantities. The reconfiguring of OTT connection 1850 can include message format, retransmission settings, preferred routing etc.; the reconfiguring need not affect base station 1820, and it can be unknown or imperceptible to base station 1820. Such procedures and functionalities can be known and practiced in the art. In certain embodiments, measurements can involve proprietary UE signaling facilitating host computer 1810's measurements of throughput, propagation times, latency and the like. The measurements can be implemented in that software 1811, 1831 causes messages to be transmitted, in particular empty or ‘dummy’ messages, using OTT connection 1850 while it monitors propagation times, errors, etc.

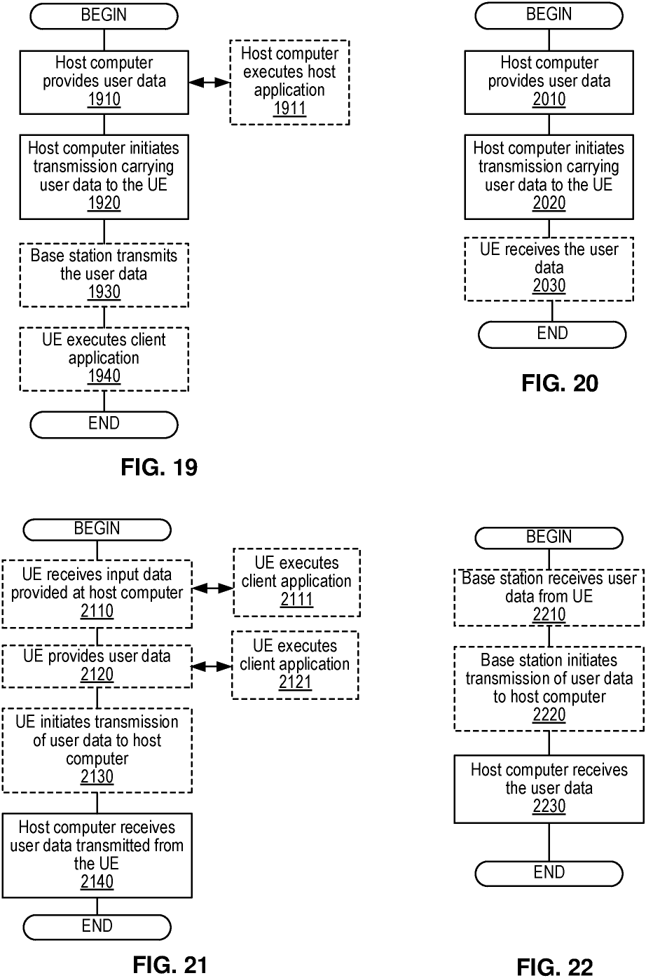

FIG. 19 is a flowchart illustrating an exemplary method and/or procedure implemented in a communication system, in accordance with one embodiment. The communication system includes a host computer, a base station and a UE which, in some exemplary embodiments, can be those described with reference to FIGS. 17 and 18. For simplicity of the present disclosure, only drawing references to FIG. 19 will be included in this section. In step 1910, the host computer provides user data. In substep 1911 (which can be optional) of step 1910, the host computer provides the user data by executing a host application. In step 1920, the host computer initiates a transmission carrying the user data to the UE. In step 1930 (which can be optional), the base station transmits to the UE the user data which was carried in the transmission that the host computer initiated, in accordance with the teachings of the embodiments described throughout this disclosure. In step 1940 (which can also be optional), the UE executes a client application associated with the host application executed by the host computer.

FIG. 20 is a flowchart illustrating an exemplary method and/or procedure implemented in a communication system, in accordance with one embodiment. The communication system includes a host computer, a base station and a UE which can be those described with reference to FIGS. 17 and 18. For simplicity of the present disclosure, only drawing references to FIG. 20 will be included in this section. In step 2010 of the method, the host computer provides user data. In an optional substep (not shown) the host computer provides the user data by executing a host application. In step 2020, the host computer initiates a transmission carrying the user data to the UE. The transmission can pass via the base station, in accordance with the teachings of the embodiments described throughout this disclosure. In step 2030 (which can be optional), the UE receives the user data carried in the transmission.

FIG. 21 is a flowchart illustrating an exemplary method and/or procedure implemented in a communication system, in accordance with one embodiment. The communication system includes a host computer, a base station and a UE which can be those described with reference to FIGS. 11 and 18. For simplicity of the present disclosure, only drawing references to FIG. 21 will be included in this section. In step 2110 (which can be optional), the UE receives input data provided by the host computer. Additionally or alternatively, in step 2120, the UE provides user data. In substep 2121 (which can be optional) of step 2120, the UE provides the user data by executing a client application. In substep 2111 (which can be optional) of step 2110, the UE executes a client application which provides the user data in reaction to the received input data provided by the host computer. In providing the user data, the executed client application can further consider user input received from the user. Regardless of the specific manner in which the user data was provided, the UE initiates, in substep 2130 (which can be optional), transmission of the user data to the host computer. In step 2140 of the method, the host computer receives the user data transmitted from the UE, in accordance with the teachings of the embodiments described throughout this disclosure.

FIG. 22 is a flowchart illustrating an exemplary method and/or procedure implemented in a communication system, in accordance with one embodiment. The communication system includes a host computer, a base station and a UE which can be those described with reference to FIGS. 17 and 18. For simplicity of the present disclosure, only drawing references to FIG. 22 will be included in this section. In step 2210 (which can be optional), in accordance with the teachings of the embodiments described throughout this disclosure, the base station receives user data from the UE. In step 2220 (which can be optional), the base station initiates transmission of the received user data to the host computer. In step 2230 (which can be optional), the host computer receives the user data carried in the transmission initiated by the base station.

The exemplary embodiments described herein provide techniques for pre-configuring a UE for operation in a 3GPP non-terrestrial network (NTN). Such embodiments reduce the time needed for initial acquisition of an NTN (e.g., PLMN) and a cell within the NTN. This can provide various benefits and/or advantages, including reducing UE energy consumption (or, equivalently, increasing UE operational time on one battery charge) and improving user access to services provided by an NTN. When used in UEs and/or network nodes, exemplary embodiments described herein can enable UEs to access network resources and OTT services more consistently and without interruption. This improves the availability and/or performance of these services as experienced by OTT service providers and end-users, including more consistent data throughout and fewer delays without excessive UE power consumption or other reductions in user experience.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that while these words and/or other words that can be synonymous to one another can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the presently disclosed techniques and apparatuses include, but are not limited to, the following enumerated examples:

1. A method, in a user equipment, UE, for handling connection reconfiguration commands received during ongoing dual-active protocol stack, DAPS, handovers, the method comprising:
receiving, prior to releasing a source cell from a DAPS handover from the source cell to a first target cell, a connection reconfiguration command from the first target cell; and
releasing the UE’s connection to the source cell, responsive to the connection reconfiguration message command;
wherein the connection reconfiguration message is a handover command specifying a handover to a second target cell or a message ordering the UE to move from a connected state to an idle or inactive state.

2. The method of example 1, wherein the connection reconfiguration command is a message ordering the UE to move from a connected state to an idle or inactive state, and wherein the method comprises releasing the UE’s connection to the source cell response to the message ordering the UE to move from the connected state to an idle or inactive state, without receiving any explicit indication that the UE’s connection to the source cell is to be released.

3. The method of example embodiment 1, wherein the connection reconfiguration message is a handover command, the handover command specifying a handover to a second target cell.

4. The method of example embodiment 3, wherein the handover command does not include an explicit indication that the UE’s connection to the source cell is to be released, and wherein the method comprises releasing the UE’s connection to the source cell without receiving any explicit indication that the UE’s connection to the source cell is to be released.

5. The method of example embodiment 4, wherein the releasing of the UE’s connection to the source cell without receiving any explicit indication that the UE’s connection to the source cell is to be released is conditioned upon having previously received an indication that implicit source cell release is permitted.

6. The method of example embodiment 3, wherein the handover command includes an explicit indication that the UE’s connection to the source cell is to be released.

7. The method of example embodiment 3, wherein releasing the UE’s connection to the source cell is in response to determining that the handover command does not include an explicit indication that the UE’s connection to the source cell is to be released.

8. The method of example embodiment 3, wherein releasing the UE’s connection to the source cell is in response to determining that the handover command does not include an explicit indication that the UE’s connection to the source cell is to be kept.

9. The method of any of example embodiments 3-8, wherein the handover command is an RRCConnectionReconfiguration message, in an LTE network, or a RRCReconfiguration message, in an NR network.

10. The method of any of example embodiments 3-9, wherein the handover command includes an indication to perform a DAPS handover to the second target cell.

11. The method of example embodiment 10, wherein the method further comprises maintaining the UE’s connection to the first target cell until the UE is instructed to release the UE’s connection to the first target cell or until the UE receives a further handover command.

12. A method, in a first target access node of a radio access network, the method comprising:
sending a first handover command to a source access node serving a user equipment, UE, for transmission by the source access node to the UE, the first handover command indicating a dual-active protocol stack, DAPS, handover from a source cell served by the source access node to a first target cell, served by the first target access node;
prior to the UE releasing the source cell for the DAPS handover, determining to perform a handover of the UE to a second target cell served by a second target access node;
transmitting a second handover command to the UE, the second handover command ordering a handover from the first target cell to the second target cell, the second handover command including an indication of whether the UE is to release the source cell upon receiving the second handover command.

13. The method of example embodiment 12, wherein the second handover command includes an explicit indication that the UE is to release the source cell upon receiving the second handover command.

14. The method of example embodiment 12, wherein the second handover command includes an explicit indication that the UE is to keep its connection to the source cell upon receiving the second handover command.

15. The method of any of example embodiments 12-14, wherein the method comprises receiving the second handover command from the second target access node before said transmitting, wherein said transmitting comprises forwarding the second handover command without modification.

16. The method of example embodiment 15, wherein the method comprises sending a handover request message to the second target access node prior to receiving the second handover command from the second target access node, the handover request message including an indication that the UE has not released the source cell from an ongoing DAPS handover.

17. The method of example embodiment 15, wherein the method comprises sending a handover request message to the second target access node prior to receiving the second handover command from the second target access node, the handover request message including an indication that the UE is to release the source cell from an ongoing DAPS handover.

18. The method of any of example embodiments 12-14, wherein the method comprises:
receiving the second handover command from the second target cell before said transmitting; and
modifying the second handover command to add the indication of whether the UE is to release the source cell upon receiving the second handover command.

19. The method of any of example embodiments 12-18, wherein the second handover command is an RRCConnectionReconfiguration message, in an LTE network, or a RRCReconfiguration message, in an NR network.

20. The method of any of example embodiments 12-19, wherein the second handover command includes an indication to perform a DAPS handover to the second target cell.

21. A method, in a second target access node of a radio access network, the method comprising:
sending, to a first target access node, a handover command for handing over a user equipment, UE, from a first target cell served by the first target access node to a second target cell served by the second target access node, the handover command including an indication of whether the UE is to release, upon receiving the handover command, a source cell for an ongoing dual-active protocol stack, DAPS, handover of UE from the source cell to the first target cell.

22. The method of example embodiment 21, wherein the method comprises:
receiving from a first target access node, prior to sending the handover command, a handover request for handing over the UE to the second target cell, the handover request indicating the UE has not released the source cell from the ongoing DAPS handover to the first target cell, wherein sending the handover command is responsive to the handover request.

23. The method of example embodiment 21, wherein the method comprises:
receiving from a first target access node, prior to sending the handover command, a handover request for handing over the UE to the target cell, the handover request indicating that the UE is to release the source cell from the ongoing DAPS handover to the first target cell, wherein sending the handover command is responsive to the handover request.

24. The method of any of example embodiments 21-23, wherein the handover command includes an explicit indication that the UE is to release the source cell upon receiving the handover command.

25. The method of any of example embodiments 21-23, wherein the handover command includes an explicit indication that the UE is to keep its connection to the source cell upon receiving the handover command.

26. The method of any of example embodiments 21-25, wherein the handover command is an RRCConnectionReconfiguration message, in an LTE network, or a RRCReconfiguration message, in an NR network.

27. The method of any of example embodiments 22-26, wherein the handover command includes an indication to perform a DAPS handover to the second target cell.

28. A user equipment (UE) configured to operate in a radio access network, the UE comprising:
radio interface circuitry configured to communicate with a network node via at least one cell; and
processing circuitry operably coupled to the radio interface circuitry, whereby the processing circuitry and the radio interface circuitry are configured to perform operations corresponding to any of the methods of claims 1-11.

29. A user equipment (UE) for operating in a radio access network, the UE being adapted to perform operations corresponding to any of the methods of claims 1-11.

30. A non-transitory, computer-readable medium storing computer-executable instructions that, when executed by processing circuitry of a user equipment (UE), configure the UE to perform operations corresponding to any of the methods of claims 1-11.

31. A computer program product comprising computer-executable instructions that, when executed by processing circuitry of a user equipment (UE), configure the UE to perform operations corresponding to any of the methods of claims 1-11.

32. A network node configured to serve one or more cells in a radio access network, the network node comprising:
radio interface circuitry configured to communicate with user equipment (UEs) via the at least one cell; and
processing circuitry operably coupled to the radio interface circuitry, whereby the processing circuitry and the radio interface circuitry are configured to perform operations corresponding to any of the methods of claims 12-27.

33. A network node adapted to serve at least one cell in a radio access network, the network node being further adapted to perform operations corresponding to any of the methods of claims 12-27.

34. A non-transitory, computer-readable medium storing computer-executable instructions that, when executed by processing circuitry of a network node, configure the network node to perform operations corresponding to any of the methods of claims 12-27.

35. A computer program product comprising computer-executable instructions that, when executed by processing circuitry of a network node in a radio access network, configure the network node to perform operations corresponding to any of the methods of claims 12-27.

36. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station’s processing circuitry configured to perform any of the steps of any of example embodiments 12-27.

37. The communication system of the previous embodiment further including the base station.

38. The communication system of the previous 2 embodiments, further including the UE, wherein the UE is configured to communicate with the base station.

39. The communication system of the previous 3 embodiments, wherein:
the processing circuitry of the host computer is configured to execute a host application, thereby providing the user data; and
the UE comprises processing circuitry configured to execute a client application associated with the host application.

40. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of example embodiments 12-27.

41. The method of the previous embodiment, further comprising, at the base station, transmitting the user data.

42. The method of the previous 2 embodiments, wherein the user data is provided at the host computer by executing a host application, the method further comprising, at the UE, executing a client application associated with the host application.

43. A communication system including a host computer comprising:
processing circuitry configured to provide user data; and
a communication interface configured to forward user data to a cellular network for transmission to a user equipment (UE),
wherein the UE comprises a radio interface and processing circuitry, the UE’s components configured to perform any of the steps of any of example embodiments 1-11.

44. The communication system of the previous embodiment, wherein the cellular network further includes a base station configured to communicate with the UE.

45. The communication system of the previous 2 embodiments, wherein:
the processing circuitry of the host computer is configured to execute a host application, thereby providing the user data; and
the UE’s processing circuitry is configured to execute a client application associated with the host application.

46. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of example embodiments 1-11.

47. The method of the previous embodiment, further comprising at the UE, receiving the user data from the base station.

48. A communication system including a host computer comprising:
communication interface configured to receive user data originating from a transmission from a user equipment (UE) to a base station,
wherein the UE comprises a radio interface and processing circuitry, the UE’s processing circuitry configured to perform any of the steps of any of example embodiments 1-11.

49. The communication system of the previous embodiment, further including the UE.

50. The communication system of the previous 2 embodiments, further including the base station, wherein the base station comprises a radio interface configured to communicate with the UE and a communication interface configured to forward to the host computer the user data carried by a transmission from the UE to the base station.

51. The communication system of the previous 3 embodiments, wherein:
the processing circuitry of the host computer is configured to execute a host application; and
the UE’s processing circuitry is configured to execute a client application associated with the host application, thereby providing the user data.

52. The communication system of the previous 4 embodiments, wherein:
the processing circuitry of the host computer is configured to execute a host application, thereby providing request data; and
the UE’s processing circuitry is configured to execute a client application associated with the host application, thereby providing the user data in response to the request data.

53. A method implemented in a communication system including a host computer, a base station and a user equipment (UE), the method comprising:
at the host computer, receiving user data transmitted to the base station from the UE, wherein the UE performs any of the steps of any of example embodiments 1-11.

54. The method of the previous embodiment, further comprising, at the UE, providing the user data to the base station.

55. The method of the previous 2 embodiments, further comprising:
at the UE, executing a client application, thereby providing the user data to be transmitted; and
at the host computer, executing a host application associated with the client application.

56. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

57. A communication system including a host computer comprising a communication interface configured to receive user data originating from a transmission from a user equipment (UE) to a base station, wherein the base station comprises a radio interface and processing circuitry, the base station’s processing circuitry configured to perform any of the steps of any of example embodiments 12-27.

58. The communication system of the previous embodiment further including the base station.

59. The communication system of the previous 2 embodiments, further including the UE, wherein the UE is configured to communicate with the base station.

60. The communication system of the previous 3 embodiments, wherein:
the processing circuitry of the host computer is configured to execute a host application;
the UE is configured to execute a client application associated with the host application, thereby providing the user data to be received by the host computer.

61. A method implemented in a communication system including a host computer, a base station and a user equipment (UE), the method comprising:
at the host computer, receiving, from the base station, user data originating from a transmission which the base station has received from the UE, wherein the UE performs any of the steps of any of example embodiments 1-11.

62. The method of the previous embodiment, further comprising at the base station, receiving the user data from the UE.

63. The method of the previous 2 embodiments, further comprising at the base station, initiating a transmission of the received user data to the host computer.

Some abbreviations used in the present disclosure

| | |
|---|---|
| 3GPP | 3rd Generation Partnership Project |
| 5G | 5th Generation |
| 5GS | 5G System |
| 5GC | 5G Core network |
| AMF | Access and Mobility Management Function |
| ARQ | Automated Repeat Request |
| CHO | Conditional Handover |
| CN | Core Network |
| C-RNTI | Cell RNTI |
| DAPS | Dual Active Protocol Stack |
| DL | Downlink |
| elCIC | Enhanced Inter-Cell Interference Coordination |
| eNB | Evolved Node B |
| eMBB | Enhanced Make-Before-Break |
| E-UTRAN | Evolved Universal Terrestrial Access Network |
| EPC | Evolved Packet Core network |
| gNB | 5G Node B |
| HARQ | Hybrid Automatic Repeat Request |
| HFN | Hyper Frame Number |
| HO | Handover |
| ICIC | Inter-Cell Interference Coordination |
| LTE | Long-term Evolution |
| MAC | Medium Access Control |
| MBB | Make-Before-Break |
| MME | Mobility Management Entity |
| NCC | Next Hop Chaining Counter |
| NG | The interface/reference point between the RAN and the CN in 5G/NR. |
| NG-C | The control plane part of NG (between a gNB and an AMF). |
| NG-U | The user plane part of NG (between a gNB and a UPF). |
| NG-RAN | Next Generation Radio Access Network |
| NR | New Radio |
| OFDM | Orthogonal Frequency Division Multiplex |
| PDCP | Packet Data Convergence Protocol |
| PDU | Protocol Data Unit |
| PHY | Physical layer |
| QoS | Quality of Service |
| RA | Random Access |
| RACH | Random Access Channel |
| RAN | Radio Access Network |
| RAR | Random Access Response |
| RAT | Radio Access Technology |
| RLC | Radio Link Control |
| ROHC | Robust Header Compression |
| RNTI | Radio Network Temporary Identifier |
| RRC | Radio Resource Control |
| Rx | Receive |
| RUDI | Reduction in User Data Interruption |
| S1 | The interface/reference point between the RAN and the CN in LTE. |
| S1-C | The control plane part of S1 (between an eNB and a MME). |
| S1-U | The user plane part of S1 (between an eNB and a SGW). |
| SDU | Service Data Unit |
| SGW | Serving Gateway |
| SN | Sequence Number |
| TS | Technical Specification |
| Tx | Transmit |
| UE | User Equipment |
| UL | Uplink |
| UPF | User Plane Function |
| URLLC | Ultra-Reliable Low-Latency Communication |
| X2 | The interface/reference point between two eNBs |
| X2AP | X2 Application Protocol |
| Xn | The interface/reference point between two gNBs |
| XnAP | Xn Application Protocol |

1-22. (canceled)

23. A method, in a first target access node of a radio access network, the method comprising:
sending a first handover command to a source access node serving a user equipment (UE), for transmission by the source access node to the UE, the first handover command indicating a dual-active protocol stack (DAPS) handover from a source cell served by the source access node to a first target cell, served by the first target access node;
prior to the UE releasing the source cell for the DAPS handover, determining to perform a handover of the UE to a second target cell served by a second target access node;
transmitting a second handover command to the UE, the second handover command ordering a handover from the first target cell to the second target cell, the second handover command including an explicit indication that the UE is to release the source cell upon receiving the second handover command.

24. The method of claim 23, wherein the method comprises receiving the second handover command from the second target access node before said transmitting, and wherein said transmitting comprises forwarding the second handover command without modification.

25. The method of claim 24, wherein the method comprises sending a handover request message to the second target access node prior to receiving the second handover command from the second target access node, the handover request message including an indication that the UE has not released the source cell from an ongoing DAPS handover.

26. The method of claim 24, wherein the method comprises sending a handover request message to the second target access node prior to receiving the second handover command from the second target access node, the handover request message including an indication that the UE is to release the source cell from an ongoing DAPS handover.

27. The method of claim 23, wherein the method comprises:
receiving the second handover command from the second target access node before said transmitting; and
modifying the second handover command to add the explicit indication that the UE is to release the source cell upon receiving the second handover command.

28. The method of claim 23, wherein the second handover command includes an indication to perform a DAPS handover to the second target cell.

29. A method, in a user equipment (UE), for handling connection reconfiguration commands received during ongoing dual-active protocol stack (DAPS) handovers, the method comprising:
receiving, prior to releasing a source cell from a DAPS handover from the source cell to a first target cell, a connection reconfiguration command from the first target cell; and
releasing the UE’s connection to the source cell, responsive to the connection reconfiguration message command;
wherein the connection reconfiguration message is a handover command specifying a handover to a second target cell and wherein the handover command includes an explicit indication that the UE’s connection to the source cell is to be released.

30. The method of claim 29, wherein the handover command includes an indication to perform a DAPS handover to the second target cell.

31. An access node configured to serve one or more cells in a radio access network, the access node comprising:
transceiver circuitry configured to communicate with user equipment (UEs) via one or more cells; and
processing circuitry operably coupled to the transceiver circuitry, wherein the processing circuitry is configured to
send a first handover command to a source access node serving a user equipment (UE), for transmission by the source access node to the UE, the first handover command indicating a dual-active protocol stack (DAPS) handover from a source cell served by the source access node to a first target cell, served by the access node;
prior to the UE releasing the source cell for the DAPS handover, determining to perform a handover of the UE to a second target cell, served by a second target access node;
transmit a second handover command to the UE, using the transceiver circuitry, the second handover command ordering a handover from the first target cell to the second target cell, the second handover command including an explicit indication that the UE is to release the source cell upon receiving the second handover command.

32. The access node of claim 31, wherein the processing circuitry is configured to receive the second handover command from the second target access node, before said transmitting, wherein said transmitting comprises forwarding the second handover command without modification.

33. The access node of claim 32, wherein the processing circuitry is configured to send a handover request message to the second target access node prior to receiving the second handover command from the second target access node, the handover request message including an indication that the UE has not released the source cell from an ongoing DAPS handover.

34. The access node of claim 32, wherein the processing circuitry is configured to send a handover request message to the second target access node prior to receiving the second handover command from the second target access node, the handover request message including an indication that the UE is to release the source cell from an ongoing DAPS handover.

35. The access node of claim 31, wherein the processing circuitry is configured to:
receive the second handover command from the second target access node before said transmitting; and
modify the second handover command to add the explicit indication that the UE is to release the source cell upon receiving the second handover command.

36. The access node of claim 31, wherein the second handover command includes an indication to perform a DAPS handover to the second target cell.

37. A user equipment (UE) configured to operate in a radio access network, the UE comprising:
transceiver circuitry configured to communicate with an access node of the radio access network via at least one cell; and
processing circuitry operably coupled to the transceiver circuitry, wherein the processing circuitry is configured to:
receive, prior to releasing a source cell from a dual-active protocol stack (DAPS) handover from the source cell to a first target cell, a connection reconfiguration command from the first target cell; and
release the UE’s connection to the source cell, responsive to the connection reconfiguration message command;
wherein the connection reconfiguration message is a handover command specifying a handover to a second target cell and wherein the handover command includes an explicit indication that the UE’s connection to the source cell is to be released.

38. The UE of claim 37, wherein the handover command includes an indication to perform a DAPS handover to the second target cell.

39. A non-transitory, computer-readable medium storing computer-executable instructions that, when executed by processing circuitry of an access node, configure the access node to perform operations according to the method of claim 23.

40. A non-transitory, computer-readable medium storing computer-executable instructions that, when executed by processing circuitry of a user equipment (UE), configure the UE to perform operations according to the method of claim 29.
